(19) United States
(12) Patent Application Publication
(10) Pub. No.: US 2011/0137991 A1
(43) Pub. Date: Jun. 9, 2011

(54) Systems and methods for management and collaboration in a private network

(76) Inventor: Lester Paul Russell, Austin, TX (US)

(21) Appl. No.: 12/928,082

(22) Filed: Dec. 1, 2010

Related U.S. Application Data
(60) Provisional application No. 61/265,689, filed on Dec. 1, 2009.

(51) Int. Cl. G06F 15/16

(52) U.S. Cl. 709/204

(57) ABSTRACT

A system and method for providing an easily installed, deployed, and administered home networking system includes, in one embodiment, a collaboration group. The collaboration group may be installed and configured to execute in a peer-to-peer model or a client/server model. In one embodiment, the collaboration group provides federation to external network services. In another embodiment, the collaboration group provides access to a private network to previously provisioned devices located outside of the private network. In yet another embodiment, the collaboration group provides data sharing between devices within the collaboration group, such as for shared calendaring and presence.

### CROSS-REFERENCE TO RELATED APPLICATION

This application claims the benefit of U.S. Provisional Application No. 61/265,689, filed Dec. 1, 2009, which is incorporated herein by reference in its entirety for all purposes.

### BACKGROUND

With the expansion of the number of personal computers and electronic devices in the realm of the private home network, end users are finding it very difficult to achieve the same level of “ease of use” they do today managing and using a single personal computer attached to the Internet.

End users with multiple personal computers are provided with user capabilities from modern operating systems that provide simple functionality for home multimedia (audio/video) distribution, file sharing, utilizing the interne for cloud based services (email, blogging, backup, file storage), and the like. These scenarios and capabilities are generally limited or are optimized for a single computing device user model, and do not provide family-focused collaboration workflows for end users with multiple personal computers.

More specifically, basic home collaboration, including, but not limited to, calendar/scheduling, home presence/messaging, shared lists (e.g., shopping, contacts, recipes, tasks), centralized parental control and management of all personal computers and devices, are all very fundamental tasks/experiences for which end users do not have a good solution. Existing home collaboration solutions are typically limited to the local computing device as opposed to multiple devices on the network, thus making the administrative task decentralized and without cross-platform support.

For example, most collaboration software is designed/modeled for a single computing device (e.g., Microsoft Outlook, Apple Macintosh Mail/iCal, and the like) and requires a connection to the internet. As a result, the ability to share calendar data among multiple computing devices in the home may be complicated by requiring a reliance on distribution/information sharing using a push through service entity (e.g., email). Further, if such a service is hosted by a third party, a first user shares a public calendar with a second user who often must obtain an account with the hosted service. In a scenario where access to the hosted service is fee-based, establishing a second account with the hosted service may unreasonably drive up costs.

If end users deploy existing enterprise group collaboration software for use in a home network, they will be faced with high technology barrier costs, and educational requirements. Since such software is designed for business and not for a smaller private end user network, the user experience (e.g., “UX”) is more optimized for corporate scenarios. Such software may also have a high price point, may require high-end infrastructure for implementation (e.g., server hardware/software, enterprise directory services on Active Directory, Network Identity Service (NIS), database servers, etc.), and may introduce a substantial administrative cost on an end user who merely wants to have a shared workflow such as a shared family calendar.

End users with multiple personal computers and devices need the ability to collaborate and manage a private cloud such as a home network and computing devices associated with the home network without relying on services made available from a public network or cloud (i.e., the internet). A user who has purchased a home storage device (e.g., NAS, home server) for their private network may want to use the home storage device as a primary backup solution with a cloud service being a secondary/alternative scenario, perhaps seen as a redundant alternative to the private backup provided by the home server. However, many consumers are not migrating to cloud services as the primary option for some scenarios (e.g. data backup) due to trust, privacy, and cost concerns. A private network environment generally includes a mix of vendor devices and personal computers which have interoperability gaps and problems between technology provided by different vendors (e.g., Macintosh and Windows operating systems) or between different versions of the same product provided by the same vendor (e.g., Windows 98, Windows XP or Windows Vista). This lack of cohesion, integration, and interoperability creates a fractured end user infrastructure, making the ability to use these systems in a distributed and collaborative way difficult, if not impossible. In a distributed environment, this lack of cohesion, integration, and interoperability may result in user workflows failing to function properly.

Moreover, configuring and managing such disparate systems as a cohesive group may be too complex for a typical end user, and in some cases even for highly skilled information technology professionals. Some configurations may require certain technology features and capabilities to be present. If these requirements are not be readily discernible, successful interaction may be extremely difficult (e.g., if Active Directory is used to centrally manage an enterprise application, end users are not likely to have a similar environment in their home network).

Discovery of devices, users and applications on the private network is also difficult due, in part, to the aforementioned issues. Discovery may also be difficult due to disparate network technologies being used by vendor-specific products, network topology/infrastructure choices, devices which are improperly configured, and/or the like.

Consumers have an adequate level of computing technology in the home to enable rich distributed collaborative scenarios beyond those used today. However, providing rich and distributed collaborative systems in this environment is difficult without incurring significant deployment and support costs due to the various errors and incompatibilities which exist.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment of the present disclosure, a cross-platform management/collaboration enabled infrastructure with a supporting application framework is provided to address issues such as the usability, configuration, deployment, and cost issues described above. The ability to integrate with external services, as well as to provide access to private cloud services to remote devices, is also provided by the infrastructure.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates one embodiment of a collaboration group (CG) system, according to various aspects of the present disclosure;

FIG. 2 illustrates cross platform support provided by an embodiment of the CG system, according to various aspects of the present disclosure;

FIG. 3A illustrates state containment within an embodiment of the CG system, according to various aspects of the present disclosure;

FIG. 3B illustrates directory store partitioning and extensibility within a CG system, according to various aspects of the present disclosure;

FIG. 3C illustrates one embodiment of catalog access control lists (ACLs) according to various aspects of the present disclosure;

FIG. 4 illustrates interaction between a distributed directory store (DS) and a CG catalog according to various aspects of the present disclosure;

FIG. 5 illustrates an example interaction when CG objects are created and replicated to multiple devices in the CG system, according to various aspects of the present disclosure;

FIG. 6 illustrates an example interaction when state changes for CG objects, according to various aspects of the present disclosure;

FIG. 7 illustrates various aspects of trust levels used within one embodiment of the CG system;

FIG. 8 illustrates interaction with security, access, and policy subsystems of the CG system, according to various aspects of the present disclosure;

FIG. 9 illustrates various aspects of a roaming administration model used within one embodiment of the CG system;

FIG. 10A illustrates various aspects of a network subsystem used within one embodiment of the CG system;

FIG. 10B illustrates various aspects of a communication channel model appropriate for use by one embodiment of the network subsystem illustrated in FIG. 10A;

FIG. 11 illustrates various aspects of a collaboration group encapsulation protocol used by an embodiment of the CG system;

FIG. 12A illustrates a collaboration group configured as a single cloud topology on a single private subnet, according to various aspects of the present disclosure;

FIG. 12B illustrates a collaboration group configured in an inter-cloud topology between two single CG clouds, according to various aspects of the present disclosure;

FIG. 12C illustrates a collaboration group configured to support remote access virtual clients, according to various aspects of the present disclosure;

FIG. 12D illustrates a collaboration group configured to support an application bridgehead topology, according to various aspects of the present disclosure;

FIG. 12E illustrates embodiments of collaboration groups configured to support an application federation topology, according to various aspects of the present disclosure;

FIG. 13 is a sequence diagram illustrating one embodiment of a method for setting up a CG system for the first time on a private network, according to various aspects of the present disclosure;

FIG. 14 illustrates one embodiment of a process for installing CG applications or extensions on two exemplary device nodes, according to various aspects of the present disclosure;

FIG. 15 is a sequence diagram illustrating one embodiment of a method for adding a new device to a CG system, according to various aspects of the present disclosure; and

FIG. 16 illustrates an inter-cloud topology according to various aspects of the present disclosure.

### DETAILED DESCRIPTION

The present disclosure is generally directed to a system for enabling management and collaboration services for end users on private networks, such as home networks and the like

One embodiment of the present disclosure provides a secure connected system infrastructure and application framework which enables cross-platform management, communication, and collaboration capabilities for computing devices on a private network. A set of native applications built on top of this infrastructure are also provided to enable core collaboration and management scenarios focused on end users. In one embodiment of the present disclosure, third-party extensions and applications may be built on top of the aforementioned infrastructure. Moreover, one embodiment of the present disclosure also provides publishing/federation support to bridge and promote data and services from the private network into a public cloud, a public network service, and/or a peer-private network.

In one embodiment, a collaboration group system includes cross platform collaboration and management infrastructure; extensible methods for add-ons; consumer focused collaboration applications; parental control focused manageability applications; public network aggregation/federation, a multiplexed input/output bus, network communication using encrypted channels; and native-identity based security for devices and applications.

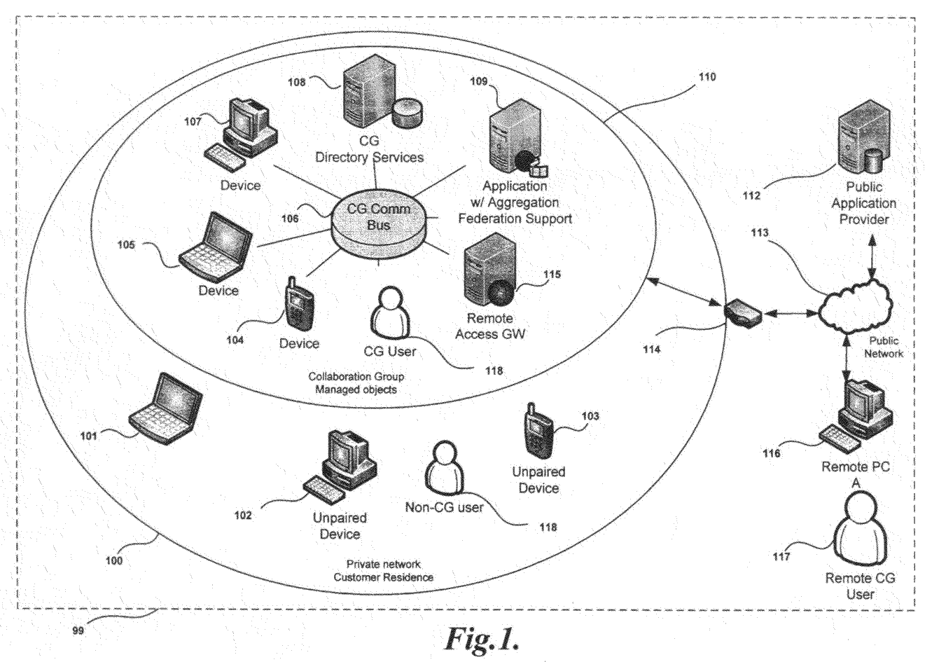

The system provides and uses a management abstraction archetype to provide logical containment and services on behalf of devices which have been enrolled and provisioned into the system, users who interact with the system, and applications which are built for the system infrastructure using, for example, native interfaces. For the purpose of this description, the management abstraction archetype is referred to as a “collaboration group,” or “CG,” as illustrated in FIG. 1 and discussed further below. A CG is similar to a realm or a domain authority for the system, within which elements and entities may be bound in a parent-container relationship. The CG functionality is enabled and supported by capabilities which provide discovery, management, enrollment/provisioning, as well as security and communication infrastructure services.

In one embodiment, the system includes one or more software stacks residing on each computing device of the collaboration group. These software stacks provide a basis for CG core services on each device, such as communication, directory, security, enrollment, registration, management and integration services (among others to support the role of the each device in the collaboration group). In one embodiment, the software stacks are capable of executing on multiple operating systems (e.g., Linux, Mac OS, Windows, Unix, and/or the like) and on any device which these operating systems will operate (e.g., a personal computer, a set top box, a cell phone, a PDA, and/or the like). In one embodiment, the software stacks coordinate in a distributed manner with software stacks on other device nodes to construct the CG topology and to enable inter-connect paths for communication between device nodes.

In one embodiment, the CG system software stacks may be divided into system and application components. The system includes the infrastructure and provides core services and facilities to interface with and use the CG system (e.g., registration, I/O system, routing, access control, security, identity, object manager, etc.). Applications are typically layered above the system and provide functional capabilities (e.g., calendar, chat, and/or the like) which enable end to end user workflows (e.g., users adding entries to shared calendar, users starting chat conversations with other present users, and/or the like).

In one embodiment, the system is divided into upper and lower level facilities, with the upper level providing application programming interface (API) integration services and the lower level providing core processor facilities. Applications may use the system's upper level to integrate with and use the rest of the CG system. The APIs provided by the upper level may use the system's lower level services to enact an intention of each API call. In this regard, calls dispatched to lower level services may occur through a protected interprocess communication (IPC) method. Access to the API framework may be limited to authorized and registered components, as described in further detail below. The overall CG system may also provide applications for management of the CG system, which may reside in the application layer.

Within the system layer, security, communication, management, and core processing facilities are provided for managing the collaboration group and respective objects (nodes, users, etc.); interoperating with the group and other objects in the system (e.g., nodes, users, etc.); enabling client/server and peer/peer applications to leverage the system through a set of integration APIs and registrar facilities; providing an I/O bus for message passing between components and nodes in the system, and for applications to use the I/O bus to send messages to paired capabilities on other nodes; and for securing operations between nodes and respective exposed interfaces. The system also establishes and manages the identity of each device and its trust relationship with other nodes in the CG system. Without the system layer, applications may not be able to communicate with other device members of the collaboration group.

In one embodiment, the system layer is configured to run within a system context of a host operating system, and therefore does not require a user logon to operate. Some system facilities, such as some portions of APIs, may run in the context of a calling application. The context in which the application layer executes is based upon whether the application is a server or a client side functional component paired to the server. The client application's component runs in a context of a logged on user executing the client application. The server application components run in a protected/isolated non-interactive mode.

In one embodiment, access to the CG system may be provided via a web-based interface where no native client is running and the user device is a non-enrolled system or a smart device. Through this interface, the device is able to use capabilities exposed by the web gateway. Gateway applications may have reduced functionality and experience than that of a corresponding client application, but users are at least able to use the reduced functionality provided by the web-based interface. Authentication in an agent-less device such as this is different for application access than in the corresponding client application. In one embodiment, the CG system may natively provide multi-user and multi-tenant support throughout the end-to-end system infrastructure.

Integrated application components expose APIs for consumption by user applications such that the definition and behavior of those APIs is subject to a specific application. The system layer provides abstraction services to the CG system and to key OS facilities/services which are used by the rest of the CG system, thus providing a uniform and integrated OS interface to help support the cross platform scenarios the present disclosure serves to enable. CG software abstracts proprietary OS-specific capability, choosing rather to expose abstraction over platform specific capability in order to enable cross-platform specific workflows and scenarios on all the managed nodes of the CG. For example, in one embodiment, the management of operating system objects is abstracted to provide end-to-end support for cross platform systems (e.g., Windows, Linux, Mac, etc.).

In one embodiment, the system layer operates as a client, a server, or a peer. In one embodiment, there is at least one server node in a server topology enabled private network. However, the collaboration group, or “HUB,” may also support server-server peering that enables, federation, advanced private networks which may have multiple source servers (independent or redundant), and bridged private networks where multiple private networks are connected as a bridged environment (e.g., connecting members of a household to a CG system on a home network when members of the household are on remote private networks).

The application layer on a given node may be responsible for providing integration to the system, interacting with corresponding paired capabilities on other server and/or client nodes, and exposing the user interaction layer (e.g., UI/UX) for a capability being enabled. The lower half of the application interacts with the collaboration group system using exposed system layer methods to support the application's end-to-end functionality (for example, sending a message from the client side of the capability to the server side of the capability, and the like). The upper half of the application provides the user experience (UX) of the feature capability. Applications may installed and registered on each node before the applications can use the system or be used by users. Server capability is installed on at least one server node, with client capability installed on each client node. This architecture may be described herein as a “server” or a “client” or a “peer” application experience accordingly.

In one embodiment, the CG system stack exposes configuration properties which authorized users may access using methods exposed by a configuration manager component. Add-on applications may also be exposed via the configuration manager component.

The configuration manager component may also be used for policy use cases, which make up core distributed configuration management scenarios enabled by the CG system. For example, the collaboration group manager (such as a parent in a household) sets permissions on a client device (such as a computing device operated by a child in the household) to limit the times which users can log on or use the system from the client device, restrict Internet access from the client device, or modify other exposed settings which the collaboration group manager would like to set.

In one embodiment, when a client first initializes with the server, the client authenticates and negotiates capabilities. This functionality may be used in a variety of ways, including, but not limited to, testing for compatibility, diagnosing problems, and upgrading capabilities.

In one embodiment of the CG system, the CG system model allows additional capabilities to be added to the system (such as backup, supportability, remote assistance, and/or the like) as they become available, by using the integration/extensibility interfaces. By providing expansion support, other capabilities may be added to the system over time. As previously mentioned, the CG system may provide system-level interfaces exposed on the upper edge of the software stack to support installation and registration of application-level capabilities into the infrastructure. Registration interfaces may provide access to the critical CG software services and components such as a registrar component of the CG software stack. This component enables the provisioning of extensions to the core system.

FIG. 1 illustrates one embodiment of a collaboration group (CG) system 99 according to various aspects of the present disclosure. The CG system 99 enables a cross-device management and collaboration platform for private networks 100. The CG system 99 provides and uses a management abstraction archetype to provide logical containment and services on behalf of devices which have been enrolled and provisioned into the system, users who interact with the system, and applications which are built for the system infrastructure using, for example, interfaces native to the CG system 99.

Devices 104, 105, 107 which are part of the collaboration group system 99 are able to interact with the CG system 99 using the CG infrastructure. Other devices 102, 103 present on the private subnet 100 can become part of the CG system 99 by way of a CG enrollment process described further below. Additionally, user accounts 118, CG applications 109, and infrastructure such as a CG communications bus 106, CG directory services 108, and a remote access gateway 115 may also be managed.

In one embodiment, user accounts 118 may be provided by underlying operating systems, and abstracted for use within the CG system 99 to enable cross-device user account management. In another embodiment, user accounts 118 may be provided as a native object within the CG system 99. CG applications 109 may be written to utilize functionality of the CG system 99. CG infrastructure provides fundamental system services to setup, manage and maintain a CG system 99. In one embodiment, a CG system 99 may include dedicated devices having specific roles such as directory services 108, application servers 109, and remote access gateways 115. The CG infrastructure resides on all devices within the CG group including those which are not providing a specialized role, such as a desktop computer device 107, a laptop/netbook device 105 and/or a mobile device 104.

FIG. 1 also illustrates other aspects of the CG system 99, including a hybrid peer/client-server rooted security control boundary 110 layered over an existing home network 100. In one embodiment, this layering is provided by a CG encapsulation protocol as discussed further below. The CG system 99 also includes support for application federation and aggregation 109 to public application providers 112 which reside on a public network 113. Lastly, embodiments of the CG system 99 may include remote devices 116 that may connect into the CG infrastructure on the private network 100 by way of one or more remote access gateways 115 configured to provide a bridgehead capability described further below.

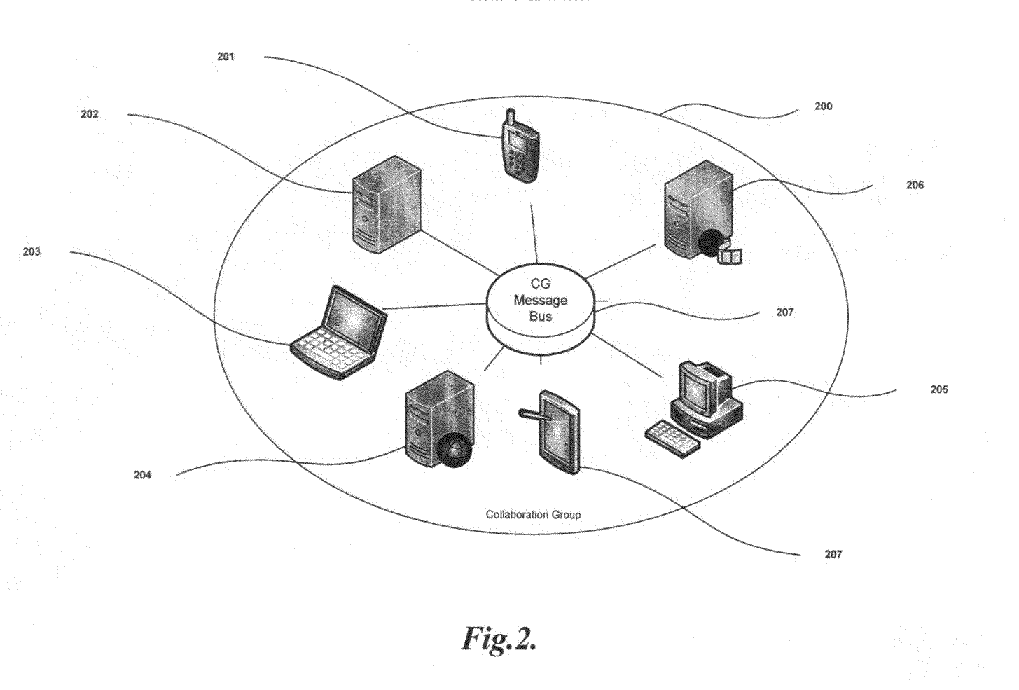

FIG. 2 illustrates cross platform support provided by an embodiment of the CG system 200, according to various aspects of the present disclosure. The CG system 200 is device profile agnostic and supports hand held devices 201 such as smartphones, tablets, and/or the like, desktop computers 205, server computers 202, 206, laptop computers/netbooks 203, and the like. Additionally, the CG system 200 is not limited to any particular operating system, such as Windows, Macintosh, Unix/Linux variants, and/or the like. For example, the desktop computer 205 may be running Windows, while the server computer 202 runs Unix, and the hand held device 201 runs iOS. Once a device is provisioned and paired to the CG system 200, the device will be discoverable, manageable and targetable by the CG infrastructure using the message bus 207, regardless of the hardware or operating system included with the device.

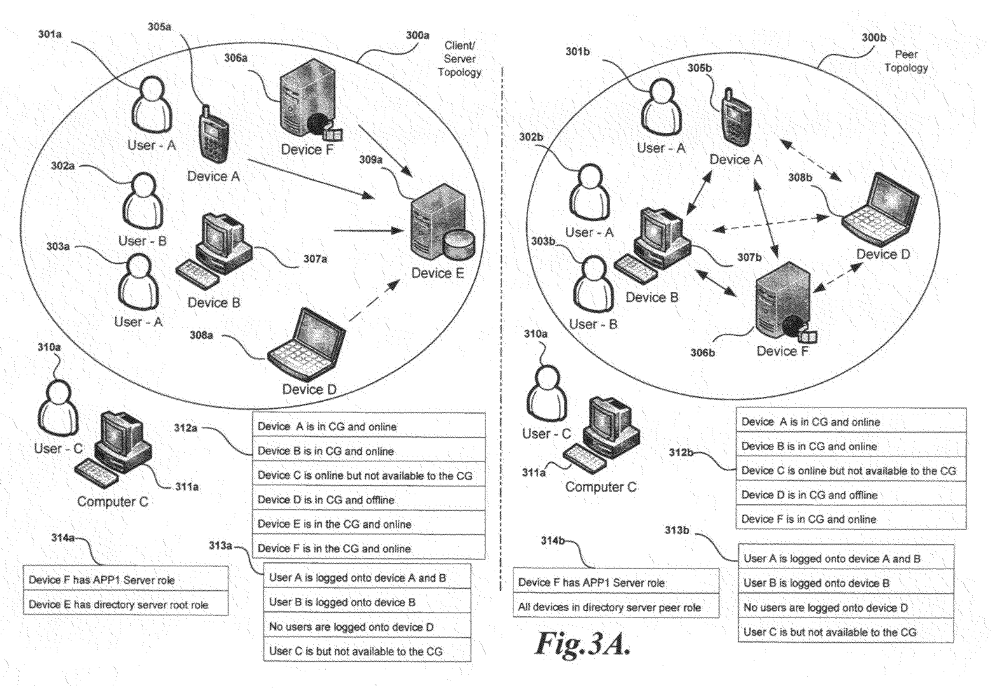

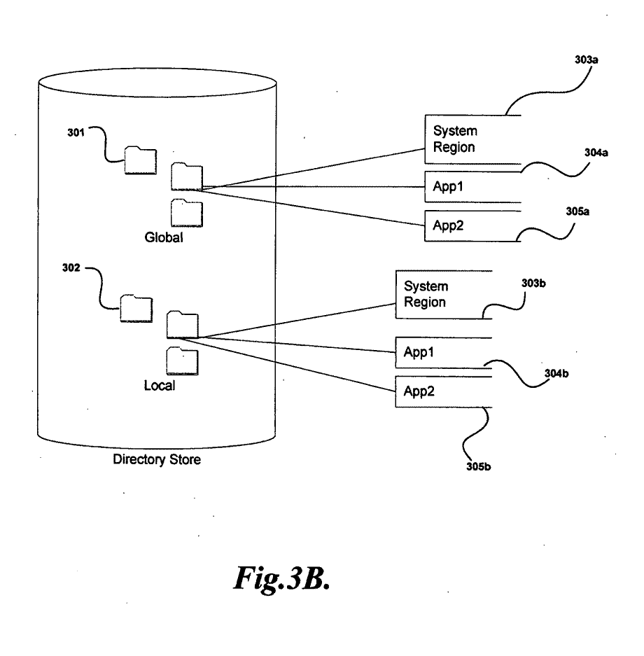

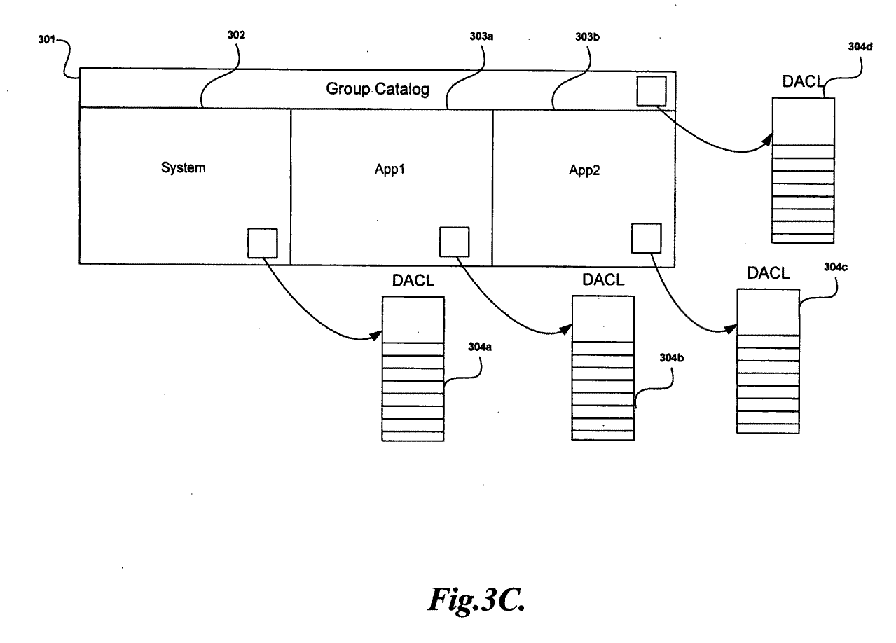

FIG. 3A illustrates state containment and distribution within an embodiment of the CG system represented in both the client-server topology 300a and in peer topology 300b. While the illustration includes state context for users 313a, 313b, devices 312a, 312b and CG application-role 314a, 314b objects, there may be a wider array of objects which are managed and exposed within the CG directory store. The CG directory store caches information locally on each node and uses propagation to synchronize context with other CG devices. The CG directory store does this to help ensure that state is distributed and available locally for efficient query and interaction by the CG system and application level callers. The CG directory store may be called the CG Catalog and the operation to synchronize data may be called Catalog Sync. System state may be stored, maintained, and distributed through the CG. System state may include a defined context of the group, objects within the group (such as nodes, users, etc.), object properties, configurations, bindings, security context, privileges, connections, transactions, etc.

In one embodiment, system state may also be partitioned. Partitioning of state may use a division model which utilizes, relative to, at a minimum but not limited to, various multiple characteristic dimensions including multi-tenant (e.g., chat as a functional tenant dimension), multi-system (e.g., Client A, Client B as system tenant dimension), multi-user (e.g., Paul and Bob as user tenant dimensions and the system may also be a tenant) and lastly local or global (which entails context being local to a node or being global for all members of the group).

System state may be shared to all devices in the group, except in the case where context is local to a particular device, or not marked as global context (context can be related either to the system or to specific applications that are running on top of the system infrastructure). This may allow the nodes in the group to make local decisions relative to the real time state of the group and relative to the impact of their local operation. Another benefit of this architecture is that it reduces additional processing outside of what should be obtained during normal group synchronization operations. Also, having shared context as a CG enables more compelling distribution scenarios to be added to the system.

FIG. 3 also depicts other devices and objects on the private subnet. Devices 311a/b and users 310a/b which are on the private IP network but have not been provisioned into the CG system 300a/b will not be available via the CG system 300a/b. A device and objects associated with the device may be added to the CG system 300a/b once the device has been provisioned to be a member device of the CG system. Objects in the CG may include, but are not limited to, devices, users, services, messages, networks, software, applications, service providers, gateways, and/or the like. Other entities not initially supported by the CG may be introduced to the CG as functionality is added to the system, or as existing functionality is extended.

Objects in the CG may be seen as “top level” objects and may have subordinate properties, attributes, and states that may interact with the system. In addition, symbiotic relationships may be found with other objects in the system, thus making the system state aware and interconnected. A device object within the CG may act as an object root archetype, since, in one embodiment, the device object may host the CG infrastructure and application software, and may provide access to network media for I/O bus interaction between nodes within the group. In instances where such a device object has been provisioned within the CG for a given device, the device may be considered a device node class object.

In one embodiment, device nodes may comprise various components including, but not limited to, the CG software stack, services, applications, users, and other elements that are exposed in a coupled manner to the device but also in an aggregated manner relative to the CG. Interaction with such objects can be used for a number of scenarios including, but not limited to, establishing identity context; setting/removing access permissions; applying/revoking policy; targeting; routing; discovering other devices, objects, and applications; achieving state awareness; monitoring; managing/configuring the CG; diagnosing/repairing issues; and/or the like.

The system provides extensibility in order to support new or modified functionality, such as adding, removing or modifying objects, attributes, or capabilities in the system. One or more objects may be managed by an object manager facility on each device node in the collaboration group system with global objects being aggregated and distributed to other collaboration group device nodes using as a shared model such as a “group catalog” or “GC.” Object scope within this construct can be global to all nodes or local. The choice of object scope may be specific to an originating node. The system does not preclude interaction with non-enrolled devices, but devices outside of the CG are not considered “managed” by the CG, and interactions with these devices do not receive the management and interoperability benefits of the CG system. These non-enrolled devices may be migrated to the CG using exposed group enrollment services to expand the level of interaction available to the devices.

FIG. 3B illustrates directory store partitioning and extensibility within a CG system, according to various embodiments of the present disclosure. The CG directory store local and global partitions are considered the primary partitions for the directory store. Each partition may support a tenant model that allows sub-partitioning and extensibility by both system and application entities. In one embodiment, applications may be prohibited from modifying information in the system partition 303a, 303b for the sake of security. In some cases, applications may still interact with read-only access for some exposed objects, states, or methods within the system partition 303a, 303b.

Data in the global scope 301 is distributed to all CG devices. This distribution helps provide foundation support for distributed “any-machine” application development. The tenanting model enforces context portioning based upon read/write regions in the system. Both the global scope 301 and local scope 302 contains a system region 303a, 303b. Applications may also create partitions in both global scope 301 and in local scope 302. However, application regions may be scoped to specific app instances. For example, the illustrated directory store includes regions for App1 304a, 304b and App2 305a, 305b. The partitions described above should be viewed as exemplary, as in other embodiments, the directory store may be partitioned differently.

Access to the group catalog data is governed using a privilege and access model with access being potentially dependent upon the context of the request relative to the namespace spanning all, or parts thereof. FIG. 3C illustrates one embodiment of an access control list (ACL) model for providing access control to the directory store and catalog objects. Placing access boundaries on the catalog by which privileged operations on the catalog can ensure protection while permitting compromise and reliable operations. In one embodiment, the model may be defined by a system of controls which govern who can access, who can read, and who can write data to the group catalog relative to partitions of objects within the system. The system of controls may be enforced by the system, but the group catalog may be exposed to application level components. The illustration shows a generalized logical structure for the CG catalog data, including a primary catalog header 301, a system block 302, and an array of app blocks 303a, 303b. Each block has a discretionary access control block (DACL) assigned to it 304a, 304b, 304c, 304d which is used for access and authorization control for the appropriate section. DACLs are similar to DACLs used in other operating systems to put a “lock” on an object by which access or specific discrete operations may be allowed or disallowed.

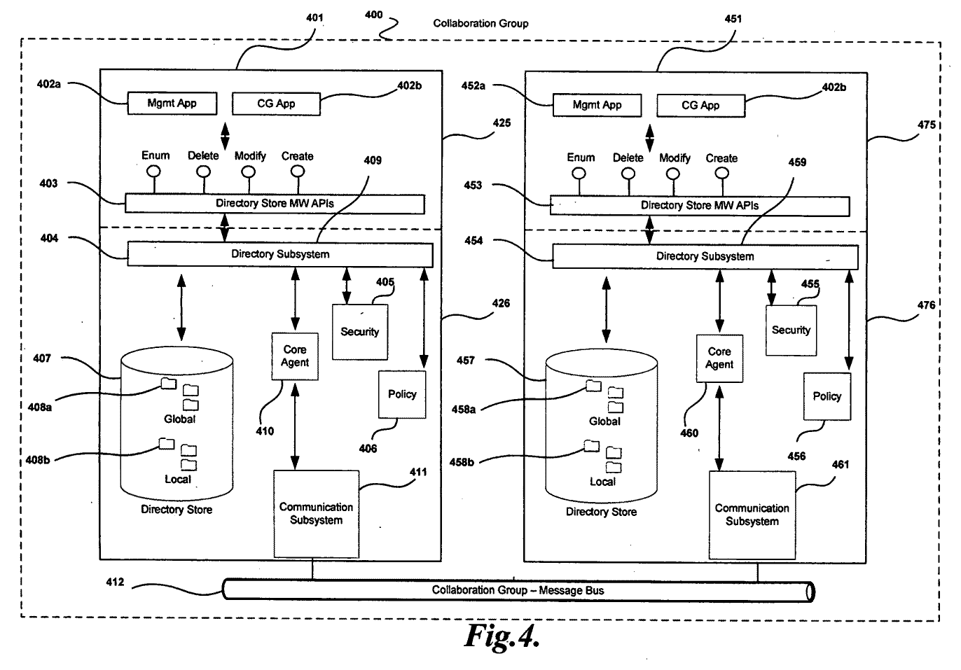

FIG. 4 illustrates interaction between a distributed directory store and related subsystems, via which an application and the CG system would perform directory store interaction on a device managed by the CG system 400 according to various aspects of the present disclosure. Two devices nodes 401, 402 are part of the CG system 400. From the first CG device 401, a CG calling application 402a, 402b may use appropriate middleware (MW) APIs 403 to query, add, delete, or modify objects within the directory store 407. The MW APIs 403 pass the request to the directory subsystem 404 which, in turn, will perform caller validation to the security subsystem 405 to verify that the API call is allowed. The caller validation checks may include checking whether the calling application is properly registered with the CG system, checking whether the caller is a valid and/or authenticable signed binary, and/or the like. If these succeed, then the directory subsystem 404 will perform a privilege check by calling into the policy subsystem 406. If it is determined that the context of the caller has the appropriate rights for the specific operation, the operation will continue processing. Authentication and policy will be discussed further below.

Once the caller 402a/b is authenticated, the directory subsystem 404 performs an appropriate transaction against the directory store 407 and commits the transaction. Depending on the operation, on the object type, or on the metadata being committed, the transaction is either considered “global” or “local” applicable. Subsequently, the transaction will be written to the appropriate partition, either the global scope 408b or local scope 408b sections, of the directory store. Upon commitment of the change in the directory store, global data from the store is synchronized to the other devices in the CG system 400 using the communication subsystem 411. This occurs when the directory subsystem 454 of the second CG device 451 issues an I/O request to the core agent subsystem 460. The core agent 460 then performs I/O and sync coordination with the communication system 411 of the first CG device 401. The communication subsystem 411 issues sync network events using the CG message bus 412 to disseminate the changes to other device members of the CG, such as the second CG device 451. The call should return with an appropriate status, such as success or failure, which can occur at any step of the transaction.

FIG. 4 also illustrates the partitioning of the application API 425, 475 and the infrastructure layers 426, 476 of the CG stack. The CG stack installed and running on every CG enabled device may be similar to those illustrated in FIG. 4.

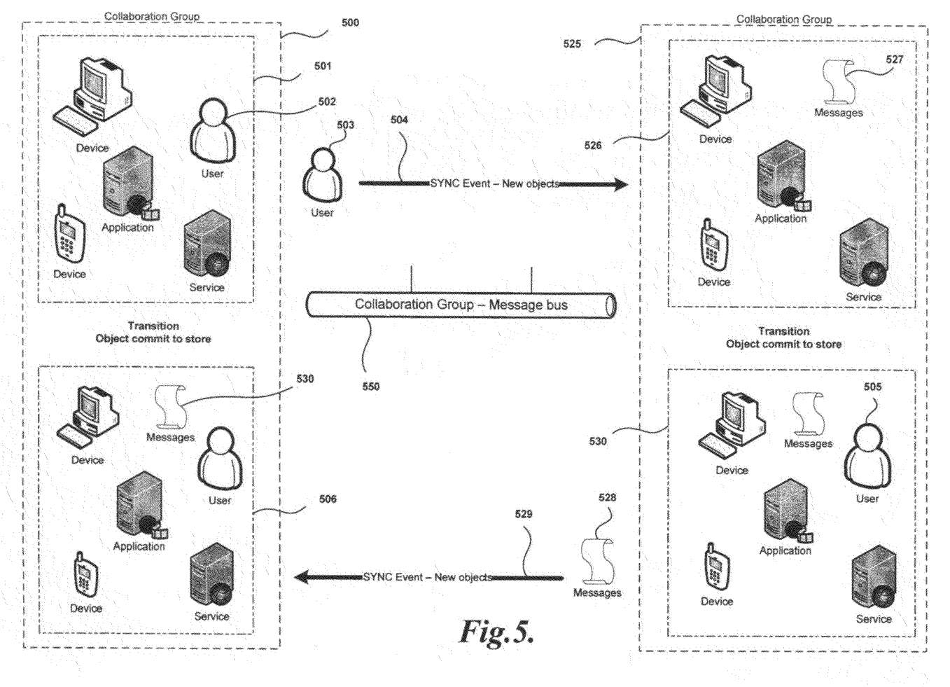

FIG. 5 illustrates an example interaction when CG objects are created and replicated to multiple devices in the CG system, according to various aspects of the present disclosure. On device A 500, a CG user 502 is created and added to the directory store 501 on device A 500. The core agent is notified of this event, and therefore the core agent starts a process to perform a directory store sync with the rest of the devices in the CG system. A sync I/O request 503 for the user object 502 is created, and is placed in an outbound sync queue of device A 500. The communication subsystem then processes a new object sync event 504. The other CG devices, such as device B 525, receive the new object sync event 504 on their inbound queue, and the remote core agent reverses the sequence during the processing of the event. The directory subsystem of device B 525 receives the object event, retrieves the user object, and commits the user object 505 to the directory store 530.

Global catalog sync operations may be used to update device nodes with context. Accordingly, all namespace global elements (and respective state and properties) may be replicated and synchronized with all device nodes. Using GC replication in this way may maximize efficiency of synchronizing state, maximize system performance and reliability, and may reduce the number of round trip communications to a central location, such as a server. Replication may not eliminate obtaining context from a different node, and as such, a device may issue an off-node request in certain scenarios. To maximize effectiveness of state transfer, replication may include bulk and incremental synchronization modes. Synchronization may normally be incremental and not bulk in nature, but this may vary depending upon a type of event triggering the synchronization operation. For example, during a post client enrollment stage in which a client obtains a full snapshot of the catalog, a bulk catalog synchronization operation would likely occur (as well as other transfers such as applications). As another example, small or minor changes in established state (e.g., user log on/log off, and the lie) may trigger an incremental synchronization. As yet another example, peer convergence which introduces merging and synchronization operations may include a bulk operation. In one embodiment, a client/server management channel (both unicast and multicast instances) may be used to optimize delivery of context.

Synchronization may be triggered by events which occur, or may be triggered when a duration of time since a previous synchronization event is greater than a threshold value. Events may occur as a result of changes (additions, deletions, modifications) to objects being maintained and managed by the group catalog on a given node. Such changes also include OS-generated events such as log on, log off, shutdown, etc. The threshold for time-related triggering of synchronization, events may be a configurable value set on multiple nodes in the collaboration group.

FIG. 5 also shows an object 527 being created on device B 525. A similar transaction 529 as the previously discussed transaction 504, but of a different type, is transmitted to CG device A. In one embodiment, sync operations are bidirectional, so during a sync operation both objects 527, 502 would be exchanged if each object 527, 502 were in the outbound sync queue. Otherwise, the sync operation executes as a result of the object creation event.

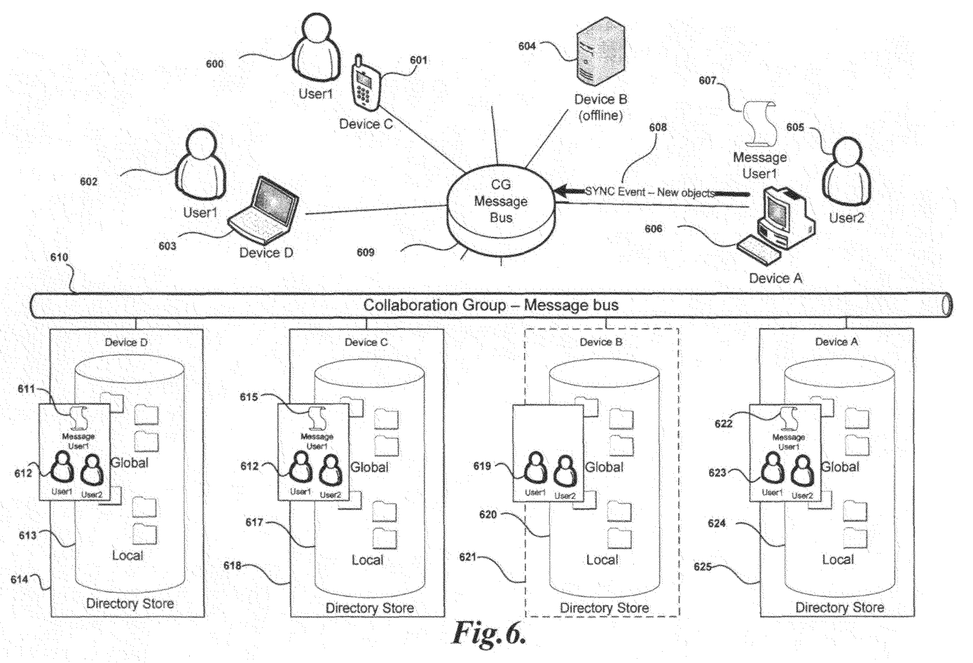

FIG. 6 illustrates an example interaction when state changes for CG objects, according to various aspects of the present disclosure. The CG infrastructure provides distributed state, and, in one embodiment, objects within the CG infrastructure are full state aggregated to each node. This allows CG application workflows to be developed that can take advantage of distributed presence for advanced queries and targeting. As mentioned in FIGS. 3A and 3B, by using the CG catalog, application data may be distributed to all devices in the CG, enabling “any device” collaboration group workflow processing of that data. This state may be used for message delivery. For example, in one embodiment, a user may be contemporaneously logged onto more than one CG device, and may be using a CG messaging application. The CG messaging application utilizes the distributed presence and data sync methods provided by the CG system. The messaging application provides a workflow wherein users are targeted via objects exposed through the directory. Messages are delivered to the users independent of what particular device they are using, as message delivery is distributed to all devices in the CG system where the application is enabled. This may allow “any device” collaboration group workflow on the message, since actions performed on the message on a first device (e.g. read, delete, change, etc.) are distributed back on the object to other devices in the CG system using catalog sync. The CG system provides the ability to enable similar distributed workflow and targeting for any application built to work within the CG system, and does not limit such functionality to messaging or classic presence applications.

FIG. 6 illustrates three examples of types of objects supported by one embodiment of the system: users, devices and application data. The upper half of the figure illustrates logical relationships between said objects, and the lower half of the figure illustrates details of the implementation of said support within the CG system.

Presence plurality, or the ability for a single user to be contemporaneously logged in to the CG system on multiple devices, is illustrated by having user 1 active logged on to two different devices. Instance 1 600 is logged onto device C 601, instance 2 602 is logged onto device D 603. By supporting presence plurality, the CG system may determine distribution for system events like notifications. Presence plurality is unique to the CG presence architecture and is not provided by previously existing presence systems. The state is effectively managed in the directory store 614, 618, 621, 625 of each device, and is replicated to each node.

The application scenario enabled in the depiction illustrates one embodiment of a messaging application workflow. User 2 605, logged in to device A 606, creates a message 607. The message is sent to user 1 via a sync event 608. User 1 is logged in, or has an “instance 600,” on device C 601, and an instance 602 on device D 603. The CG system delivers the message to both device C 601 and device D 603, and the user may interact with the delivered message 607 via a user interface layer of the application on either device. Any changes made to the message object on either device may be synchronized by the CG system and be observed on each system that the message 607 was delivered to. For example, if user 1 decided to use user instance 600 logged onto device C 601 to reply to the message, a message response may be sent to user 2 605, the original message object 607 may be changed to have a status of “read” and “replied” in the application inbox, the sent reply message (not shown) may be saved in a sent box, and, upon synchronization, the “read” and “replied” status of the message 607 may be visible in application instances on both device C 601 and device D 603.

The illustrated device scenario shows device presence, and provides real time device presence within the CG system. The availability of real time device presence information may change as devices shutdown, restart, or generally go offline. In the figure, device B 604 is offline. While offline, device B 604 maintains its last known information from the CG system. As shown, the directory store 621 of device B 604 includes the user presence information 619 for user 1 and user 2, but does not include the information regarding the message 607 sent after device B 604 was taken offline. Upon return to runtime state, device B 604 may resynchronize its directory store 621 with the CG system.

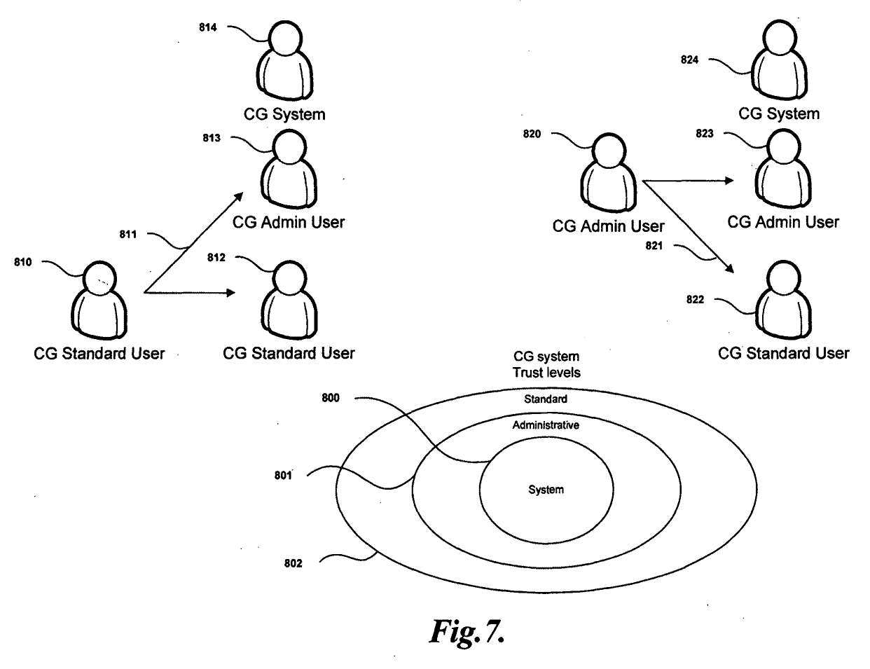

FIG. 7 illustrates various-aspects of trust levels used within one embodiment of the CG system. A system trust level 800 is the highest level of trust. The system trust level 800 may be reserved by core infrastructure, and includes the highest privileges to manage the environment, including discrete system functions. An administrative trust level 801 is the next trust level of the CG system, and may be reserved for users of the CG system having administrative rights. Users associated with the administrative trust level 801 may be allowed to manage the complete CG system, and may have the highest interactive privileges of any users of the CG system. A user associated with the administrative trust level 801 is similar to an admin within a traditional operating system. The lowest trust level in a CG system may be a standard user trust level 802. The standard user trust level 802 may be reserved for users of the CG system who do not have administrative rights. These users may be allowed to perform a limited set of operations that are unlikely to impact users other than themselves, and may simply be allowed to use the capabilities and applications that users associated with the administrative trust level 801 have configured to be available on the CG system. Identity and user accounts may map to principal identities within host operating systems, and may also map to group fundamentals with the CG system that provide abstraction necessary for cross platform support and a consistent security model.

FIG. 7 also illustrates concepts of delegation and elevation within the CG system, which allow a user to specify another user to perform an operation on their behalf. This may be similar to Unix and/or Windows, wherein a principal identity can elevate to another identity of a higher privilege level, such as from a standard user to a super user (SU)/administrator, or to a different identity of a privilege level similar to the original user. Unlike these other implementations, in one embodiment of the CG system, users are not permitted to elevate to the system trust level 800 context, though privileged system context processes may perform impersonation in order to perform some operations.

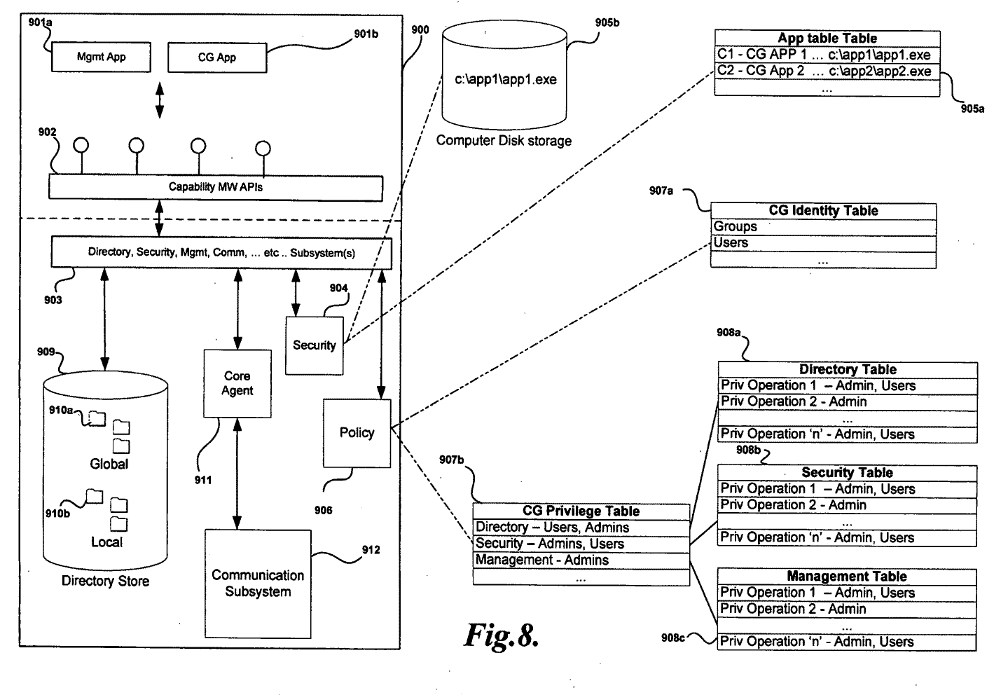

FIG. 8 illustrates interaction with security, access, and policy subsystems of the CG system, according to various aspects of the present disclosure. A single device node 900 that is part of the CG system is illustrated. A CG calling application, such as a management application 901a or a CG application 901b, may use appropriate middleware APIs 902 depending upon the subsystem APIs being accessed. The MW APIs 902 pass the request to a corresponding subsystem 903, which in turn will first perform-caller validation via a security subsystem 904. The caller validation checks may include checking whether the calling application 901a, 901b is properly registered within an App table 905a of the CG system, and/or checking whether the calling application 901a, 901b is a valid and/or authenticable signed binary by referring to a copy of the executable stored on a computer-readable medium 905b.

If the caller validation checks succeed, then the subsystem 903 may perform a privilege check by calling into the policy subsystem 906. The policy subsystem 906 may check data sources such as a directory table 908a, a security table 908b, and/or a management table 908c, as referenced by a CG privilege table 907b, to determine whether the context of the caller 907a, 907b has appropriate rights for the specific operation. If so, the operation will continue processing. Authentication, and policy will be discussed further below.

Once the caller 901a, 901b is authenticated, the subsystem 903 may cause the appropriate transaction to be performed within the directory store 909, and may cause the transaction to be committed to the directory store 909. As discussed above, depending upon the operation, object type, or metadata being committed, the transaction may either be considered as global or local applicable. Accordingly, the transaction may affect an appropriate partition, either a global scope 910a or a local scope 910b section, of the directory store 909. Upon commitment of the transaction, global data from the directory store 909 may be synchronized to other devices in the CG system using the communication subsystem 912. This may occur in response to the subsystem 903 issuing an I/O request to a core agent 911. The core agent 911 may perform all I/O and sync coordination with the communication subsystem 912. The communication subsystem 912 issues sync network events using a CG message bus (not shown) to distribute object changes to other device members of the CG. The call should return with an appropriate status, success or failure, which can occur at any step of the transaction.

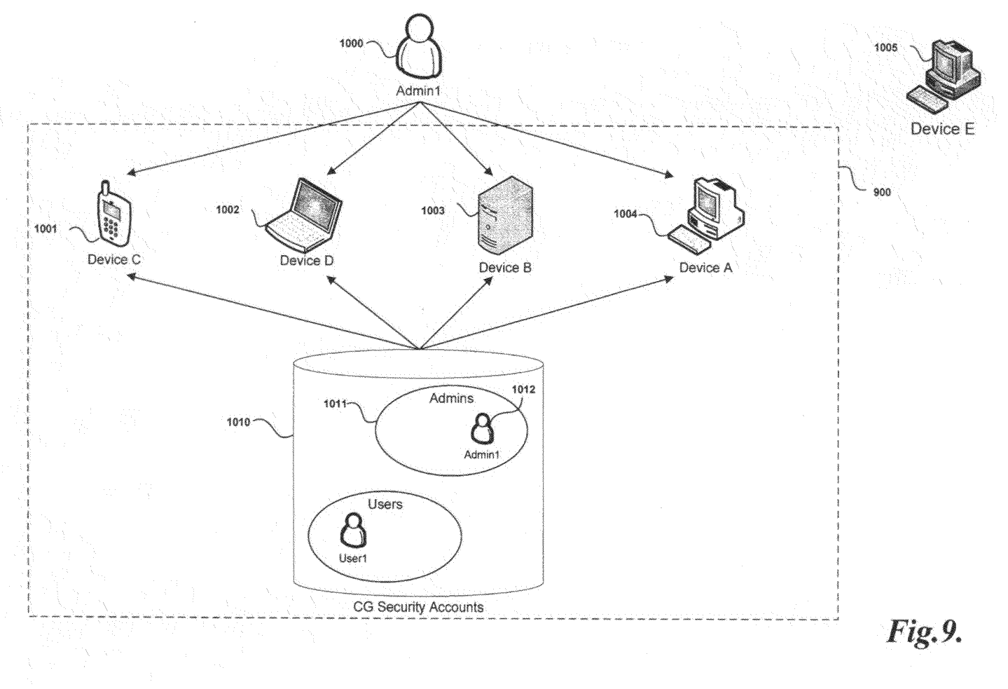

FIG. 9 illustrates various aspects of a roaming administration model used within one embodiment of the CG system. Administration boundaries 1006 within the CG system allow administration of the CG system to occur via any device which is in the CG system. In this picture, a user Admin1 1000 is designated in a CG security accounts store 1010 of the CG system as a CG Admin 1012, and is therefore authorized to log on or use any of the devices 1001, 1002, 1003, 1004 in the CG system, as they are valid objects that may be manipulated by an administrator. Admin1 1000 may otherwise be allowed to manage device E 1005, but since device E 1005 is not within the administration boundary 1006 of the CG system, there is no guarantee that admin identities and/or credentials such as passwords will be the same. Further, if CG software stacks are not installed on the device or device E 1005 has otherwise not been provisioned into the collaboration group, sync of accounts, passwords, policies, and privileges does not occur between device E 1005 and the CG system.

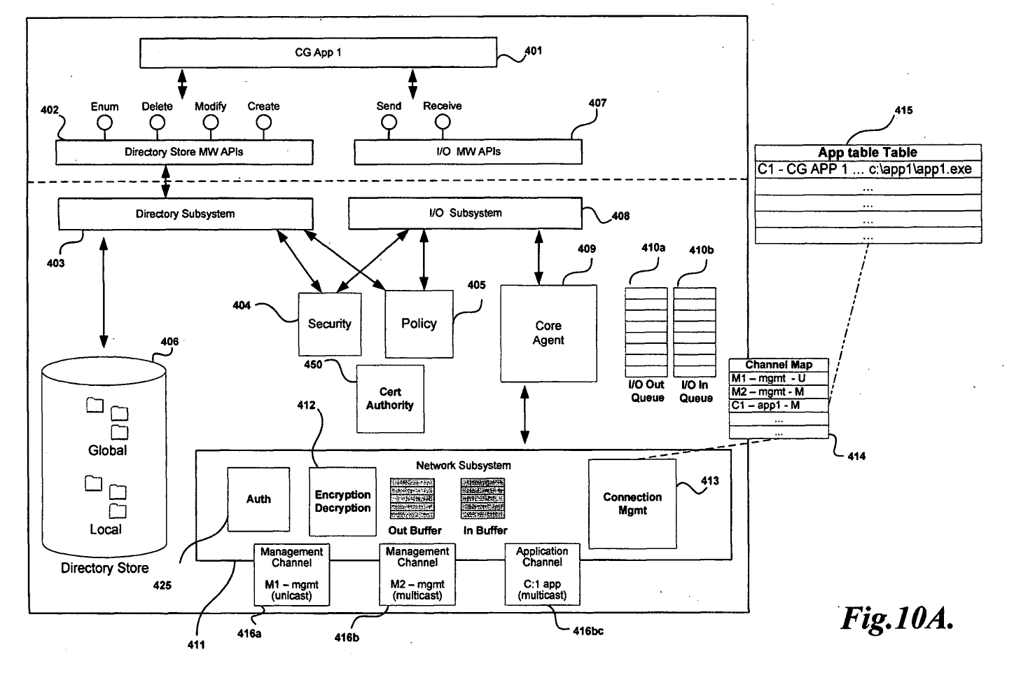

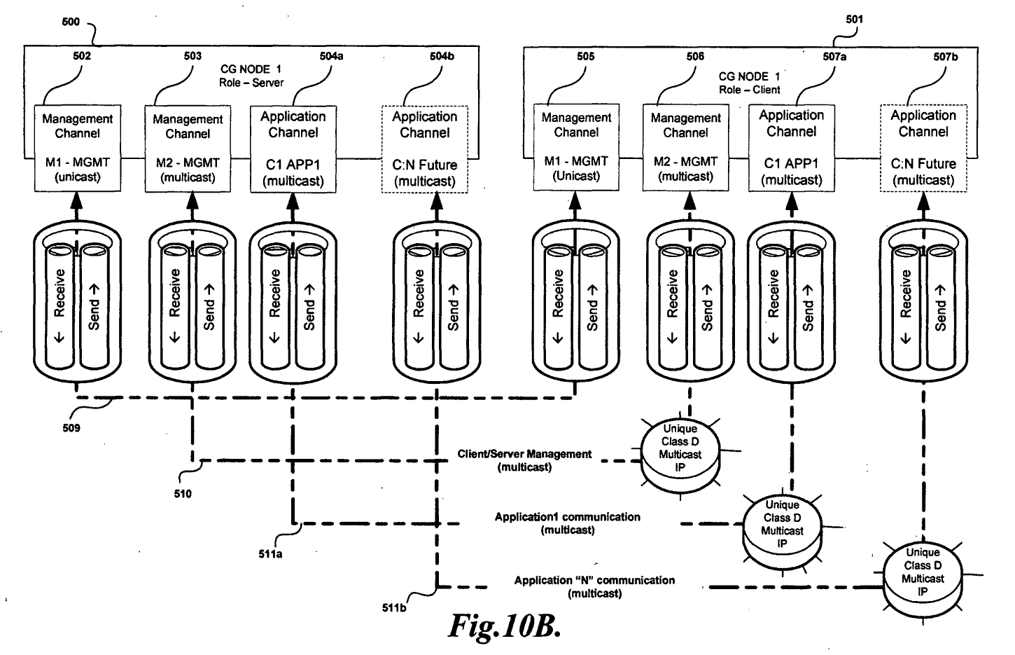

FIG. 10A illustrates various aspects of a network subsystem used within one embodiment of the CG system. A system core infrastructure component may provide an end-to-end secure input/output (I/O) communication subsystem. This core infrastructure component may provide a basis for I/O interaction in scenarios including applications communicating with the system, the system communicating with another system, and applications communicating with other applications through the system. In cases of applications communicating with the system or other applications, a system-provided API 407 is used to perform the I/O. An I/O subsystem 408 may provide secure bi-directional communication channels using a multiplexed message bus design which uses request/response protocol archetype semantics. Request/response semantics may be used to manage and correlate transmission round trip.

In embodiments wherein a bi-directional pipeline is used, message requests may originate from any direction, such as client to server, server to client, and peer to peer. The direction of a message request may be based upon the intention of the issuer of the request (e.g., system messages, application layer functionality, etc.). TCP and UDP protocols may be used to create unicast channels 416a and multicast channels 416b, 416c between CG devices in the group. Unicast communications may be used primarily for supporting core client/server management functions. Multicast communications may be used to provide core application client/server functions. In addition, some management supporting functions, such as catalog synchronization or discovery, may also be based upon a multicast channel created specifically for management auxiliary functions.

In one embodiment, application multicast channels may be created in an instance model. Accordingly, for each application added to the system (e.g., chat, calendar, etc.), there is a dedicated multicast channel 416c for that application to use. The CG protocol frame for the communication bus may be a binary stream protocol which has routing, request/response semantics, and other attributes used by the CG system in the protocol header. Application data may then be encapsulated as payload in the CG protocol frame structure. The CG protocol frame may be completely encrypted, and may be transported over network media inside a TCP or UDP packet.

The I/O subsystem 408 may interface with the object manager 406 to determine target and routing context when creating a bus packet. Applications may also use the object manager 406 to establish targeting context when passing a request message to the I/O subsystem 408. In this case, the I/O subsystem 408 validates the targeting provided by an application I/O request with the object manager 406 to evaluate and determine whether the message can be delivered. If the message can be delivered, processing will continue. In response to determining that a message cannot be delivered, error handling is performed.

The I/O processing system may include further components, such as APIs 407 for applications to use to, for example, create and submit I/O requests; an I/O dispatcher that processes I/O requests/responses; an I/O dispatch queue configured to store pending requests/responses and including an I/O out queue 410a and an I/O in queue 410b; an application table 415 and/or a channel map 414, which may provide binding details on where to deliver specific requests; a connection management component 413 configured to make orchestration decisions for I/O; cryptographic features 412 that may be used to encrypt or decrypt messages; and/or a network manager 411 configured to provide a channel system to unicast endpoints or multicast groups, to manage an out buffer and an in buffer, and to perform related processing. The I/O system supports client/server and peer topologies for both system management and application level interactions. As such, the bus system may be topology agnostic and may be implemented to provide distribution facilities. Higher level authorities (such as a CG core agent 409, applications 401, and/or the like) may make decisions concerning relevance of data sent and received.

In one embodiment, security may be based upon identity context established as part of system provisioning (e.g., server setup or client enrollment). Identity contexts may be provided via extended purpose authentication x509 certificates, and may be either a client certificate (OID: 1.3.6.1.5.5.7.3.2) or a server certificate (OID: 1.3.6.1.5.5.7.3.1). Other types of certifications may be used as appropriate for specific operations. Data leaving nodes should be encrypted, and should be decrypted upon receipt.

A secure session may be set up before messages are transmitted between a client node and a server node. A mutual authentication-enabled handshake between the client node and the server node may be used to establish a trust relationship between the client node and the server node. In one embodiment, TLS may be used, but the security infrastructure is designed so that an authorization type may be negotiated during connection initialization and setup, thereby allowing other protocol types to be added or used based upon binding requirements of an end point. Transport encryption is provided by TLS on unicast channels and may use mutual authentication between client/server, server/server, or client/client scenarios. Messages transmitted over the unicast channel may also be encrypted, ensuring a maximum level of protection on management channel functions.

Multicast does not support TLS, so, in one embodiment, the CG system may provide message level encryption with augmentation of TLS-like behavior over multicast. The context for the encryption over the application channels may be similar to the TLS enabled scenarios, thereby ensuring consistency. Additional precaution may occur within the I/O frame packet to have extra context indicators within the exchange that can only be decoded and correlated to the end system. This extra context indicator may be provided via the TLS-enabled management channels, and may be stored in the object manager for access by the network manager for assertion of authorization. For example, a server node may provide a list of active CG nodes which have active sessions with the server node, along with their associated IP addresses. This list may be shared with each node as part of global catalog synchronization, since these CG nodes are targetable by the I/O manager. When a node receives a multicast packet, it may decode the packet and look for the extra context indicator which was put into the origin packet and encoded before being transferred to the OS network socket. The receiving node may correlate the extra context indicator to the trusted data in the object manager before allowing the packet to process up the I/O stack for delivery.

As a core protocol design feature, the message bus is designed to provide a flexible data contract with flexibility for the I/O system and applications by supporting binary “BLOB” as the payload structure for the bus protocol. Applications may simply define their client/server protocol as a structured data type, and pass data to the system via the I/O APIs 408 for delivery as an I/O Request Message. The system may then serialize and encapsulate the BLOB into a request frame, and push the request frame onto the bus. Subsequently, the message is received and may be unencapsulated from the bus frame, deserialized back into its application BLOB, and provided for dispatch processing to application layer functionality on the receiving node. By using binary as the bus protocol, substantial performance gains are achieved over using higher level protocols like XML which, while declarative, may add overhead without adding substantial value as a transport bus technology. However, since applications within the CG system may still use XML at the application level, such an application may simply provide XML-formatted data as the payload in the request frame.

In one embodiment, a method for performing a bus protocol transaction between an originating station and a server station may be used. On the originating station, an application layer program 401 receives an instruction to send a message to a corresponding server program. The application layer program 401 structures data according to schema requirements particular to the application layer program 401, and prepares the data for submission to the I/O subsystem 408 via the I/O APIs 407. The application layer program 401 calls an appropriate I/O method (e.g., HubIoRequest, and/or the like) of the I/O APIs 407. The I/O subsystem 408 receives the request, and validates the caller and the message. The I/O subsystem 408 then places the request on the outbound I/O queue 410a.

The network subsystem 411 takes the request off the outbound I/O queue 410a and creates a request frame with appropriate header details. The network subsystem 411 encapsulates the request into the payload section of the request frame. The request frame is then encrypted by the encryption/decryption component 412, and the encrypted request frame is placed into the network outbound queue. The network distributes the encrypted request frame to the server station identified in the header details, and the originating station waits for a destination station acknowledgement (ACK). When the response acknowledgement is received by the originating station it is processed and details are pushed back up the software stack. This data is returned to the application layer program 401 via an I/O callback function so that the calling application may process the response (if it expects one).

On the server station, the process is almost reversed. The encrypted request frame is received by the server station in a network inbound queue. The network subsystem 411 of the server station decrypts, parses, and validates the request frame. Then, the server station transmits a response ACK to the originating station. The message from the frame payload is extracted and placed in the I/O in queue 410b. The core agent 409 delivers the message from the I/O in queue 410b to the appropriate server application for handling of the client request. When processing the frame, if the server station determines that the targeted application capability is missing, removed, improperly configured, or simply not responding, a delivery failure (e.g., non-delivery-report (NDR), or other message) may be issued back to the originating station in place of the response ACK, which provides this context to the calling application with appropriate actionable context for handling.

In distribution cases, a message is sent from an originating station and destined for one or more destination stations. Since multicast application channels are being used, all nodes receive the same transmitted message. However, instead of plain multicast processing, the message is processed by the CG protocol for routing purposes. If a received multicast message is not applicable to a given application channel multicast group, members of the application channel multicast group may ignore processing the message in a way similar to network MAC/PHY transmission behavior. Management channel I/O may be different, in that the server directs messages to a client or the client to the server.

Further, in one embodiment, the CG system provides implicit I/O targeting protection for paired functionality that protects cross-application targeting of I/O messages. By way of example, “Extension A” may register a client and server pair in a CG system in which “Extension B” is also registered. In this instance, extension B cannot target messages to extension A, and will receive an error in response to such an I/O request attempt. This feature may be provided via explicit extension IDs. Extension IDs are provided during registration so that channel bindings for client/server pairs are unique and have isolation and abstraction for the pieces which make up the end-to-end I/O bindings for the application.

In one embodiment, the CG system may hide a physical path which makes up the lower pipeline objects (e.g., socket handle, multicast target, remote registration callback, etc.) which bind the client and server application components through the I/O bus. For example, the application may pass a higher-level abstraction target (e.g., a symbolic syntax such as “<target> <param>”, “<TARGET:USER> <ENTITY:BOB>”) with application context (e.g., a symbolic syntax such as “<app:command> <param> <param>”, “<APP:CI-IAT> <SENDER:JACK> <MSG:Hi bob this is jack>”) that is delivered to the target into a system I/O request API 407. On intake, the system verifies the abstraction targets from applicability, permissions, and availability perspectives. For example, the system may determine whether “APP:CHAT” is associated with a valid end point, whether “JACK” is a registered user, whether “JACK” is authorized to send chat messages, whether “BOB” is a registered user, etc. This feature may help frame the type of context the system will affirm before trying to deliver, but may indicate failure if the conditions are not satisfied. Subsequently, the message is routed through the appropriate channel and to the target entity.

The present disclosure discusses the I/O system in more detail. However, the above examples were provided to give an outline of how an application caller might generally interface to the API layer and use the system in order to reach its corresponding and paired capabilities on another node. As outlined herein, the CG system provides end-to-end protected I/O facilities in order for local/remote functionality to interoperate. Since the path is a protected path, only registered functionality can access and use this protected path. While similar, these features are not the same as true binary level RPC. In this regard, some characteristics provided by the present disclosure are akin to but also relate to other derived forms for remote/local communication. The caller in the present disclosure does not need to specify any stub, endpoint, call or communications semantics that are typically involved for RPC solutions. Callers simply use the discovery, target, and delivery abstractions the system provides and send the intention in the data structure they can specify, which the system delivers on their behalf.

The components illustrated in FIG. 10 may also interact to transmit and receive data via a method as follows. The CG application 401 enumerates the directory store 406 via the directory store APIs 402 to find objects to which data will be targeted. Upon receiving a request from the CG application 401 for object data, the directory store APIs 402 call the directory subsystem 403. The directory subsystem 403 uses a security component 404 to perform an authentication check on the CG application 401, which, as illustrated, is white listed in the app table 415. The directory subsystem 403 also uses a policy component 405 to perform a policy check. Once the CG application 401 is thereby approved to access the directory store 406, the directory subsystem 403 performs an enumeration call to the directory store 406, and the directory store APIs 402 return the retrieved data to the CG application 401.

Next, the CG application 401 creates an I/O request and calls the I/O APIs 407 to send the request to a targeted object. The I/O request may contain information identifying a paired capability, such as a unique capability identifier, a reference to an object in the directory store 406, information identifying a channel, and/or the like. The I/O request may also contain information to be used by a receiving application. In response to receiving the I/O request, the I/O APIs 407 call the I/O subsystem 408. Similar to the discussion above with respect to the directory subsystem 403, the I/O subsystem 408 uses the security component 404 perform an authentication check on the CG application 401, which, as illustrated, is white listed in the app table 415. The I/O subsystem 408 also uses the policy component 405 to perform a policy check. Once the CG application 401 is thereby approved to perform I/O, the I/O subsystem 408 dispatches the request to the outbound queue 410a managed by the core agent 409. The core agent 409 processes the request, and transfers it from the outbound queue 410a to the network subsystem 411.

The network subsystem 411 packetizes the request to a CG protocol structure, such as a CG request frame, and the encryption/decryption component 412 encrypts appropriate sections of the packet. A connection manager facility 413 determines channel routing details for the destination application from a channel map 414. The connection manager facility 413 puts the request on an output buffer associated with an appropriate channel, such as application channel 416c. The network subsystem 411 passes a status of the dispatched request back to the CG application 401. The CG application 401 may also process messages returned from the receiving endpoint via a receive callback function bound to the I/O APIs 407.

FIG. 10B illustrates various aspects of a communication channel model appropriate for use by one embodiment of the network subsystem of the CG system. Communication channels 500 established on device 1 are configured to perform in a server role. Communication channels 501 established on device 2 are configured to perform in a client role. It is understood that, since the communication channels may be bi-directional, either device 1 or device 2 may be acting as a client or as a server at any given point, and that device 1 is illustrated as a server and device 2 is illustrated as a client for ease of discussion.

Management channel one 502 is unicast, and provides bi-directional point to point communications. Streams traveling on management channel one 502 may be encrypted by default at the transport and message levels, and the pipeline may be multiplexed for highly efficient pipelining requests. In one embodiment, a channel such as management channel one 502 is present by default on the CG system, and may be reserved for CG system operations instead of being available to application callers.

Management channel two 503 is multicast, and provides bi-directional broadcast communications. Broadcasts on management channel two 503 may be encrypted by default at the transport and message levels, and the pipeline may be multiplexed for highly efficient pipelining requests. In one embodiment, a channel such as management channel two 503 is present by default on the CG system, and may be reserved for CG system operations instead of being available to application callers. In one embodiment, both management channel one 502 and management channel two 503 are addressable by a well known channel identifier, such as “Channel One” and/or “Channel Two,” in each deployment of the CG system.

Application channels, such as application channel one 504a and application channel two 504b, are multicast, and provide bi-directional broadcast communications. Broadcasts on application channels may be encrypted at the transport and message levels, and the pipeline is MUXed for highly efficient pipelining requests. In one embodiment, application channels may be created and managed as an array in the CG system. In order to maximize isolation, security, and performance, one embodiment of the CG system may use one channel per application. Applications may be assigned a channel designator when initially installed and registered within the CG system. For example, a first installed CG application (APP1) is illustrated as being installed, registered and enabled to use application channel one 504a. Interconnect paths for each channel are also depicted 509, 510, 511a, 511b, to show the isolation boundaries of data transfer, and to show that each channel 502, 503, 504a, 504b on device 1 is configured to communicate bi-directionally with a corresponding channel 505, 506, 507a, 507b on at least device 2.

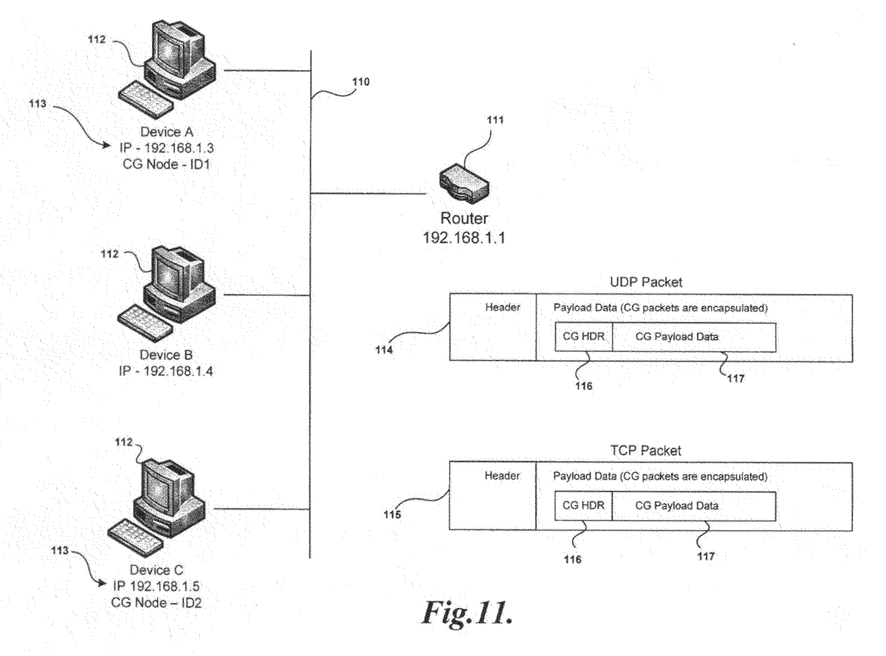

FIG. 11 illustrates various aspects of a collaboration group encapsulation protocol used by an embodiment of the CG system. The CG system may leverage an existing private IP network 1110 in a home. Devices 1112a, 1112b, 1112c operating on the network 1110 may have been assigned IP addresses dynamically via DHCP on the router 1111, via an equivalent networking device, via statically assigned private addresses, and/or the like. Devices that are provisioned and configured to be members of the collaboration group are assigned an identifier 1113 the CG protocol will use to refer to the device when communicating within the CG system. The CG protocol may be encapsulated within the payload section of either a UDP packet 1114 or a TCP packet 1115. The CG protocol includes a header section 1116 which may be used for transport level functions within a CG system such as routing, authentication, and protocol control functions for ensuring the payload section 1117 is delivered, processed and acknowledged by CG system devices. The payload section 1117 includes application-level context, and is processed by the application layer of the CG system. The communication subsystem, such as the communication subsystem 411 illustrated in FIG. 4, may be responsible for packing and unpacking I/O requests into CG packets. The communication subsystem may also be responsible for interaction with unpaired devices accessible on the local subnet, such as the unpaired devices 101, 102, 103 illustrated in FIG. 1. The communication subsystem may also be responsible for interaction with the subnet router 1111, and with devices such as off-network devices 112, 116 outlined in FIG. 1. The communication subsystem provides all authentication of inbound/outbound requests, and may also utilize encryption network I/O including transport and message wrapping.

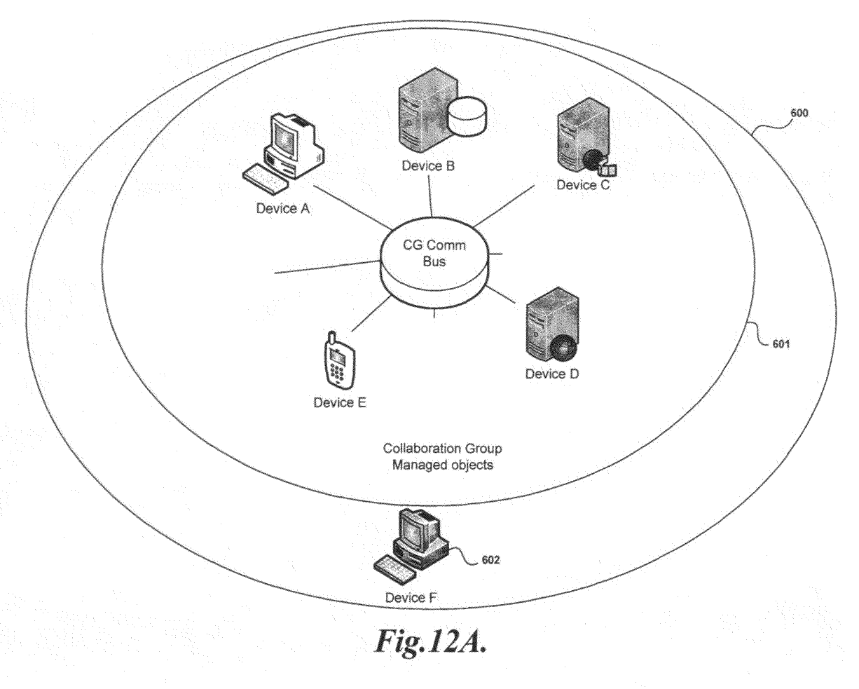

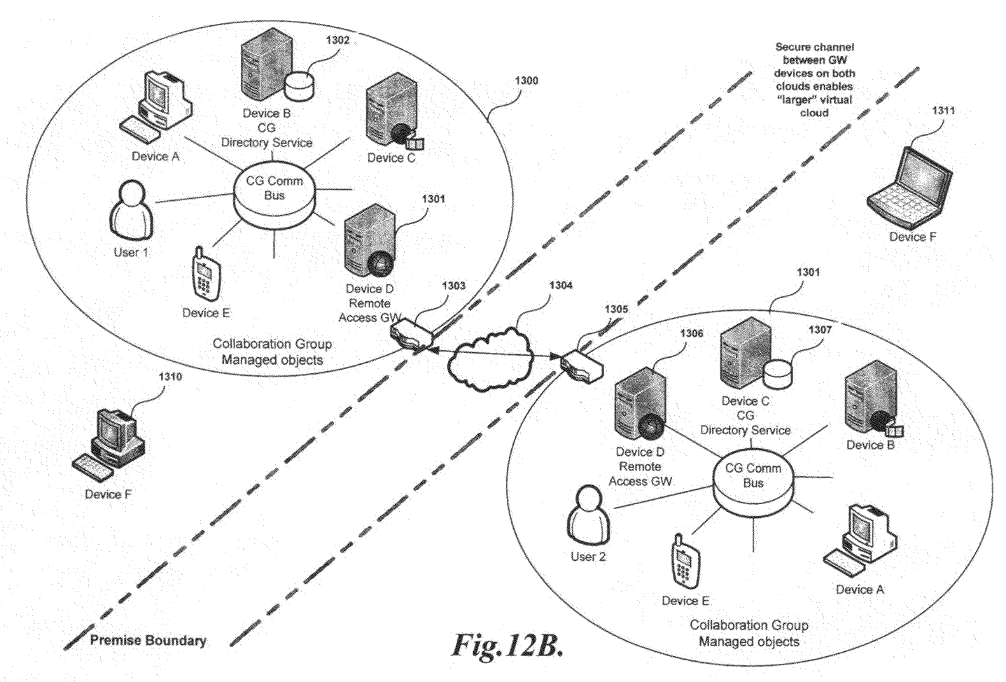

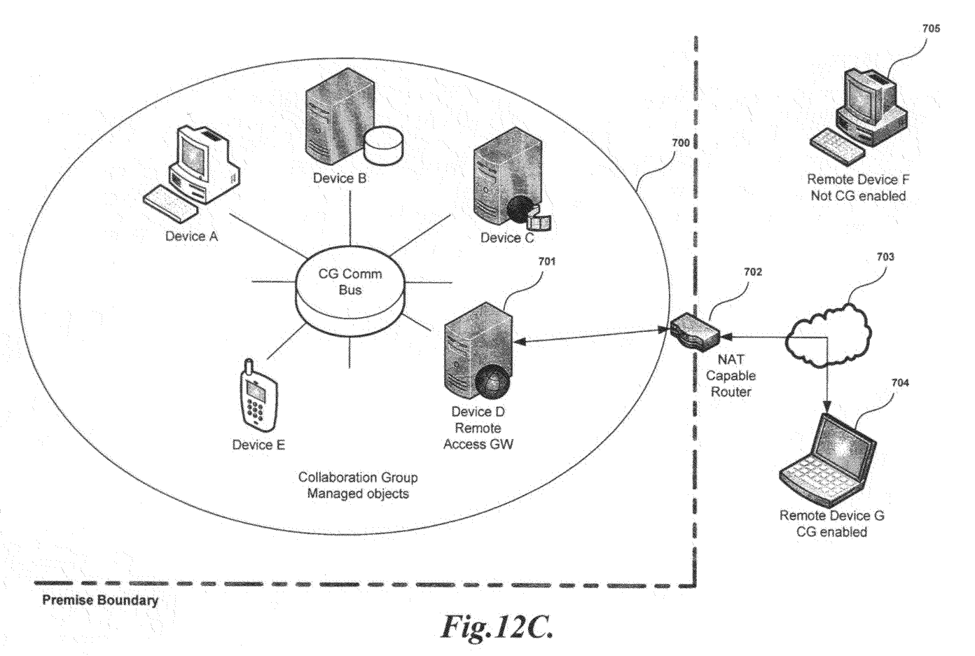

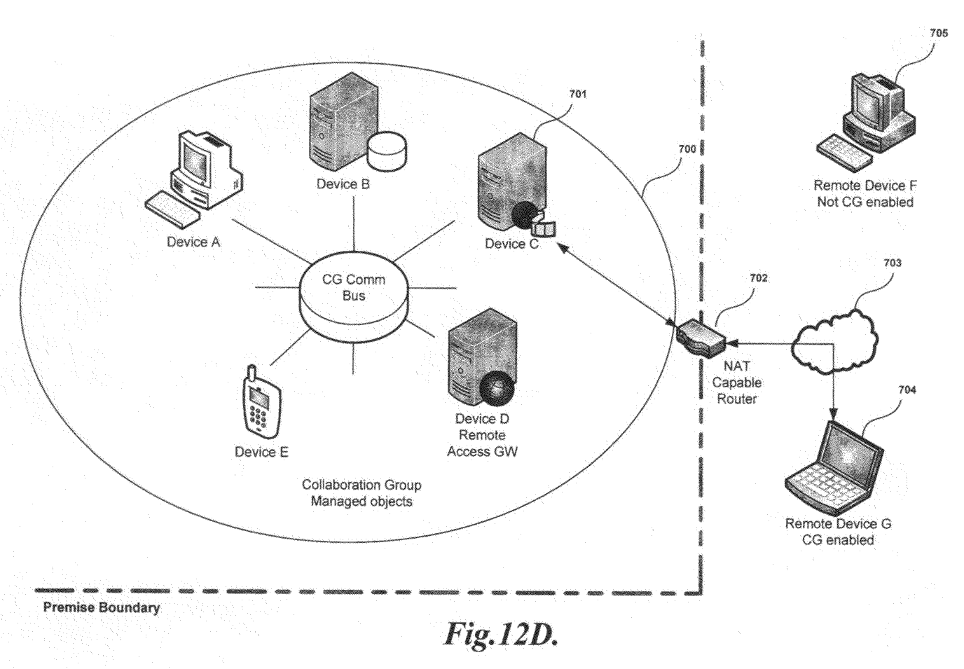

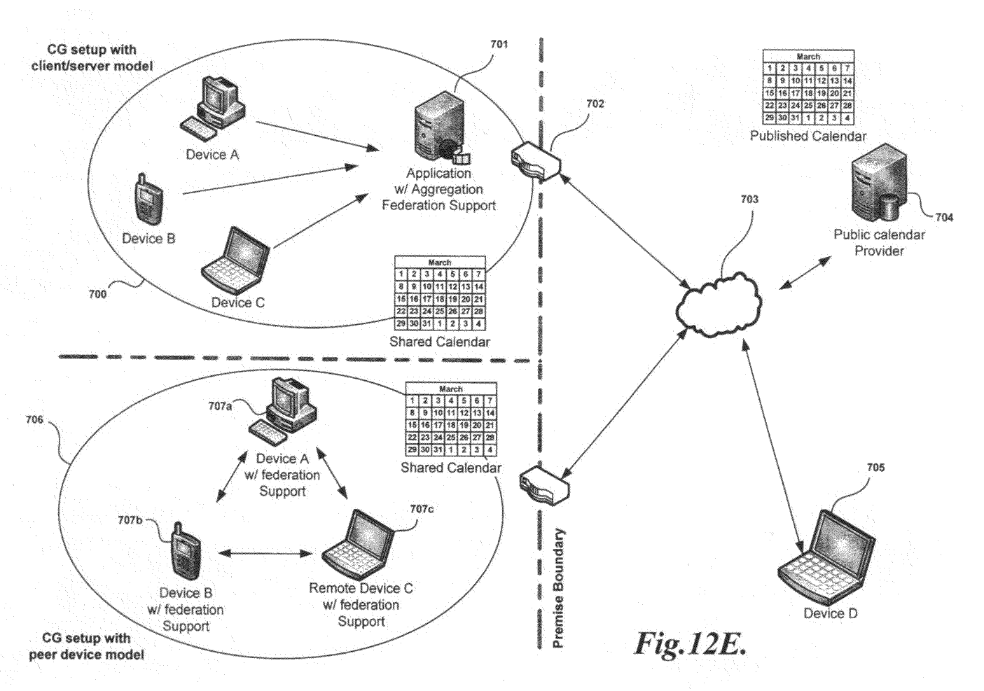

FIG. 12A illustrates a collaboration group configured as a single cloud topology 601 on a single private subnet 600, according to various aspects of the present disclosure. Each of the devices in the single cloud topology 601 are CG-enabled devices that have been provisioned into the CG system, and may interact with each other via the CG system. Device F 602 is outside of the CG management scope, but is still addressable by the devices in the single cloud topology 601 using standard networking protocols such as TCP/IP and/or the like, assuming firewalls and any OS provided feature ports are enabled. Device F 602 may, at a later time, be provisioned into the CG and become part of the single cloud topology 601 via CG enrollment methods discussed further below. The single cloud topology 601 may be configured to support at least two types of enrolled device topology models: a server model in which a centrally managed server device acts as the authority for the collaboration realm; and a peer-peer model, where authority is hybrid. Hybrid authority includes a combination of consensus authority (mutually inclusive operations between “n” peered nodes), and standalone authority, where a given node may control the fate of a specific operation only when it has an explicit impact to the given node's specific operation.

In another embodiment, the CG system provides support for inter-group topologies, wherein two private groups may have established an explicit relationship in which a CG server in one private network has a trust relationship with a CG server on another private network. This may be seen as a classic branch office model, but is also supported specific to end user private networks, thereby enabling extended scenarios and peer scenarios that would otherwise not be available between two private end user networks.

FIG. 12B illustrates a single collaboration group configured in an inter-cloud topology between two single CG clouds 1300, 1301 in two locations separated by a public network 1304. In one embodiment, the two single CG clouds 1300, 1301 are located at different physical premises. In another embodiment, the two single CG clouds 1300, 1301 may be located in the same physical premises, but may reside on different subnets separated by a third network.

An inter-cloud topology may be used to combine distributed family household private networks into a private inter-cloud. In one embodiment, the system may use a public network 1304, such as the interne and its related services, along with respective network devices 1303, 1305 at each location to provide IP-level transport and name resolution to locate a public IP address associated with each site, and to allow the remote access GW systems 1301, 1306 to establish inter-site communication. In another embodiment, the remote access GW systems 1301, 1306 may be manually configured with addressing information of the network devices 1303, 1305 participating in the inter-cloud IP-level transport.

Once communication between the first CG cloud 1300 and the second CG cloud 1301 has been configured, any device in either the first CG cloud 1300 or the second CG cloud 1301 is able to communicate with any other device in the first CG cloud 1300 or the second CG cloud 1301. Devices outside of the CG boundary such as device F 1311 in site two, and device F 1310 in site one are not able to communicate to CG enabled capabilities or devices. While devices within the first CG cloud 1300 may communicate with device F 1310 via normal networking protocols such as TCP/IP, the inter-cloud topology may not allow devices outside of the first CG cloud 1300, such as the devices within the second CG'cloud 1301, to communicate with device F 1310 at the first site, if device F 1310 was otherwise unreachable from said devices. Joining two sites will be discussed further below. Access control is governed by use of TLS with client identity which has been provisioned to the client device.

FIG. 12C illustrates a collaboration group 700 configured to support remote access virtual clients, according to various aspects of the present disclosure. The collaboration group 700 is similar to the single cloud topology 601 illustrated in FIG. 12A, but with a remote access role enabled on device D 701. Access to the collaboration group 700 via device D 701 may be limited to remote devices which have been previously enrolled and provisioned for the CG system 700, such as remote device G 704. In one embodiment, devices which are not yet enrolled, such as remote device F 705, may not be allowed to connect to device D 701. One common use for this type of topology may be to allow an end user to configure a CG system to easily be accessed by a mobile device which is sometimes present on the premise subnet, and is sometimes online on subnets outside of the premises. In one embodiment, the CG system may use a public network 703, such as the interne and its related services, to provide IP-level transport and name resolution for remote device G 704 to locate a public IP address associated with the network device 702, and to allow device D 701 to establish a bridgehead for remote device G 704 to access the collaboration group 700. In another embodiment, remote device G 704 may be manually configured with the addressing information of the network device 702. Access control is governed by use of TLS w/client identity which has been provisioned to the client device.

FIG. 12D illustrates a collaboration group 710 configured to support an application bridgehead topology, according to various aspects of the present disclosure. The collaboration group 710 is similar to the single cloud topology 601 illustrated in FIG. 12A, but with application bridgehead capability for a specific CG server application enabled on device C 711. Access to the collaboration group 710 via device C 711 may be limited to remote devices which have been previously enrolled and provisioned for the CG system 710, such as remote device G 714. In one embodiment, devices which are not yet enrolled, such as remove device F 705, may not be allowed to connect to device C 711. One common use for this type of topology may be to allow an end user to configure a CG system to easily be accessed by a mobile device which is sometimes present on the premise subnet, and is sometimes online on subnets outside of the premises. Compared to the collaboration group 700 illustrated in FIG. 12C, the remote client G 714 does not utilize full network access to the remote CG. Instead, remote client G 714 merely connects to the application hosted in server form by device C 711. In one embodiment, the CG system may use a public network 713, such as the internet and its related services, to provide IP-level transport and name resolution for remote device G 714 to locate a public IP address associated with the network device 712, and to allow device C 711 to establish a bridgehead for remote device G 704 to access the application hosted on device C 711. In another embodiment, remote device G 714 may be manually configured with the addressing information of the network device 712. Access control is governed by use of TLS w/client identity which has been provisioned to the client device.

Federation to out-of-network services (e.g., cloud services, public network services, and/or the like) may be supported by topologies of the CG system. Providing access to such services may be considered a “foreign extranet” extension to the topology and trust boundary of the CG system. When the collaboration group is configured to operate in a client-server topology, all federation access will occur directly via the designated server for a federated end-to-end application. When a collaboration group is configured to support a peer topology, federation access may occur from any of the device nodes within the CG system topology. However, a federating device node may only be able to federate context relative that node and users accessing that node.

FIG. 12E illustrates embodiments of collaboration groups configured to support an application federation topology, according to various aspects of the present disclosure. A client/server topology 720 configured to support application federation, and a peer-to-peer topology 726 configured to support application federation are shown. Federation includes “aggregation” to an off-network entity. In the illustrated embodiment, shared calendar application information is federated beyond the borders of the CG systems 720, 726 to a public calendaring provider 724. Application federation may serve to offload some of the “public” access of application information from the CG infrastructure, and thereby reduces infrastructure requirements for the private subnet.

Application federation topologies utilize network services provided by a public network such as the internet 723, and network devices 722, 726 located on the respective private networks IP-level transport and DNS name resolution to locate the public application provider 724. Additional application workflows/capabilities may be enabled in both application topologies 720, 726 to support exchanging data with the external entity. The server 721 of the client/server topology 720 may exchange application data with the provider 724. Each device 727a, 727b, 727c of the peer-to-peer topology 726 may individually exchange application data with the provider 724.

For federation scenarios, a different identity method may be provided. An identity map may be used to associate a public service identity with a private group identity. In the client/server topology 720, the server 721 may act as a gateway and proxy to external entities. A subscription from the provider may install on the server node and, in effect, enroll the CG system to the provider's service, from the context of the server 721 representing the group. During external service provisioning, the server 721 may expect to receive a client identity, subscription identity, or relative certificate based claim from the provider 724. This context may be used to establish credentials for the server 721 for interactions with exposed web methods of the provider 724. The server 721 may use this certificate, along with any additional provisioned service context (e.g., security bindings, URLs, etc.), to communicate or proxy according to the public subscription provider 724.

Once subscription provisioning is complete, the server 721 may notify clients of the federated capability being available, thereby allowing clients which have federation-enabled applications to take advantage of this enabled path to the cloud. The server 721 may also aggregate requests to be sent to the public provider 724, since the server owns the context binding. This may be managed with an identity context map (“CG identity->External identity”) for the purpose of controlling and ensuring the integrity of the external identity. This mapping may also help protect service bindings, and to ensure that said bindings are used properly during the lifetime of the relationship with the external entity authority.

In the peer-to-peer topology 726, application federation may be similar to the expectation that any peer can talk to the public service provider 724 without the virtue of going through a dedicated server since, in effect, more than one peer may act as a server. In this model, subscription sharing is enabled that is, in effect, very similar to the server topology described above. For example, in one embodiment, node A 727a may have a subscription to service A, and node B 727b may have a subscription to service B. Node A 727a may use a subscription path provided by node B 727a to access service B, and, conversely, node B 727b may use a subscription path to service A provided by node A 727a.

This may be available when node A 727a and node B 727b are configured as peers, but may not be available otherwise. In peer-to-peer mode, users on a particular node, or an administrator, may also be able to act as an administrator for services the particular node shares with other nodes in the collaboration group. By contrast, in server mode, the group administrator is responsible for sharing services to nodes in the group. In either case, permission may be based upon, but not limited to, users who can access, which devices have access, when can access occur and potentially more granular levels within the service (e.g., Bob is only able to read data from the service but not post to the service, and the like).

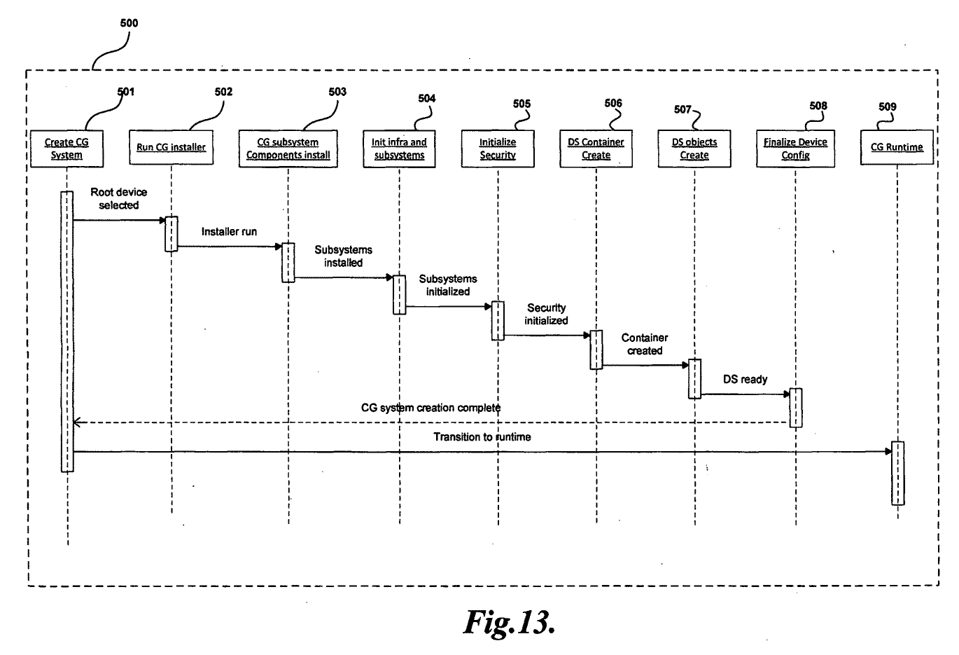

FIG. 13 is a sequence diagram 500 illustrating one embodiment of a method for setting up a CG system on a private network, according to various aspects of the present disclosure. An IP-based environment having devices capable of installing the CG system software has already been established. During the first stage 501, an end user selects a device to act as a root CG device and as the CG controller. Next, at stage 502, the end user runs a CG system software installation package on the selected CG controller device. During installation, the installation package places computer-executable components for providing the CG software stacks on a tangible computer-readable storage medium associated with the CG controller device, registers components with an operating system of the CG controller device, and performs any pre-requisite configuration. In the subsystem component installation stage 503, the installation package installs, registers, and configures computer-executable components on the CG controller device that are associated with as-yet uninstalled subsystem components. Next, at stage 504, the installation package initializes CG system infrastructure pieces including the core agent; supporting daemons/services, OS UI integration points; and subsystems such as storage, directory, security, management, authentication, network, security, and/or the like. Once the core infrastructure is ready, the installation package initializes security of the CG system in stage 505. This may include, but is not limited to, configuring the certificate authority, establishing root CA credentials, establishing user and device identifiers, and mapping OS security principals to the CG security system.

Next, in stage 506, the installation package sets up the directory store. First, a container within the physical directory store is created. A unique container identifier is created and the container type, such as a client/server type or a peer device type, is specified. Default objects, behaviors, policies, roles and permissions are created within the directory store in stage 507. Next, in stage 508, the installation package finalizes device configurations including roles, default settings, and policies relative to the specified container type. At this point, creation of the CG system is substantially complete, the device role may proceed to runtime status in stage 509, and the installer package terminates. The end user may then use the runtime applications (both CG management and default collaboration apps which were installed during this sequence).

CG applications provide the user experience for a given capability, and should function if the devices on which they are being installed or run have been provisioned to the collaboration group; the associated capability is properly provisioned into the infrastructure (i.e., paired client and server components are both installed); and the executing user has sufficient permissions to interact (run, read, write, manage, etc.) with the application. As an example of what may occur in the case of un-paired capabilities in one embodiment of the present disclosure, an exemplary scenario is the case where the server-side component is removed or unavailable. In this scenario, a client device may not be able to execute an application-specific operation. Accordingly, API calls to the infrastructure may provide a contextually relevant error indicating the non-delivery (NDR) of the call to the server-side functionality due to the inaccessible capability. Conversely, if a client-side capability is removed or un-registered from a targeted client, the NDR may originate from the destination client to be delivered to the server for error handling.

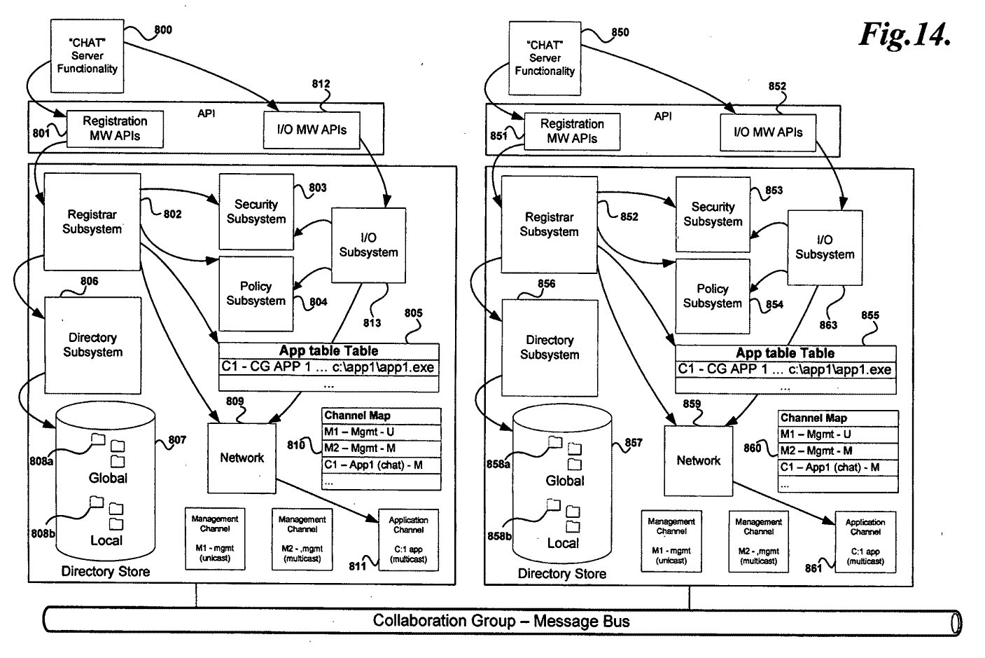

The basic functionality of the CG system may be enhanced through extensions, which may also be referred to as add-ins. As illustrated in FIG. 14, an extension or add-in may be registered via a call to a registration API 801 which, in one embodiment, may process the registration request as follows. Similar to the discussion above with respect to other API calls, the call to the registration API 801 is validated by a security subsystem 803 and a policy subsystem 804 with respect to both the calling user and the calling application. Information about the add-in is retrieved, including but not limited to an extension identifier, a capability, and description information/attributes. The add-in identification information is registered with the object manager, and the add-in capabilities are registered with the dispatcher. The network manager system 809 then creates and binds an application channel 811 to the add-in, and updates the channel map 810 accordingly. The add-in is then published into the group catalog 807 for context distribution to the other CG nodes in the group. The add-in or extension should be functional for each node on which this process is performed (e.g., on the client and server, or on all peer nodes, etc.).

For server extensions, the registration process may include registering and publishing a corresponding client agent so that the client agent may be distributed to new devices during client bootstrap and enrollment. Client agents may be provided at an appropriate server distribution point, and the client registration/enrollment process is updated to add the new client agent to the installation manifest. Though this is a common scenario, there are exceptions wherein a server extension is installed in a non-paired manner (i.e., without a corresponding client agent). For example, if a server-side application capability provides proxy/federation services for the group, or a unique management function which does not require changes on any client nodes to operate, a corresponding client agent may not be installed.

During registration, applications may create new object types and state properties in the object store and catalog. This context may be viewed as explicit to the registering application, may be implemented using attributes (or other descriptive manners supported by GC and CG), and may be shared globally in order to have the application's context (objects, states, properties) discoverable for use by other consumers (such as by other applications, or by the system). In this model, access to these objects or state may be read-only (RO) for other applications, and full-access for the source application. One exception may be for system processes, which may have full access to the objects and state. When an application is successfully registered, the application then may access runtime APIs and begin using the system.

When a given application makes calls to system runtime APIs, the application may be validated for use with the system. The verification and validation procedure may include a context of the caller and calling process, a signature of the extension/application binary, a session context of API calls, object access permissions, and/or the like. In one embodiment, only signed/trusted binaries may be allowed to operate with the infrastructure, with validation occurring during installation and runtime operations. This validation may occur during each API call.

In one embodiment, a unique session is created when an application is initialized. The session is set up during a first API call, by transmitting a unique identifier of the application to the CG infrastructure. The unique identifier is also provided to the CG system during registration.

In one embodiment, applications may not replace core CG infrastructure or core collaboration applications. However, applications may add new functionality which expands and extends the capabilities of the CG system (e.g., remote management, DVR control, entire home backup, and/or the like).

In one embodiment, the CG system provides a standard set of applications. The standard set of applications provided by the core infrastructure may enable group management, communication, and shared user workflows integrated to the CG. This includes, but is not limited to, user and device management, policy management, update management, chat, presence, notifications, calendaring, information sharing (such as lists, tasks, and/or the like), publishing, and federation to service entities on public networks. The provided capabilities are designed to use the collaboration group infrastructure to enable consumer centric collaboration and management scenarios across varying types of computing platforms (e.g., Windows, Mac, Linux, Unix, iOS, Android, and/or the like) and consumer devices (multi-function cell phones, PDAs, set top boxes, game consoles, personal computers, and/or the like), all of which access the private network infrastructure (wired or wireless) and have the collaboration group software installed.

Applications may also interface with a licensing system to ensure group policies/rules are enforced (e.g., seat count, transferring, sharing, etc.). For collaboration applications, users may work together in a shared way with the provided applications, since they provide workflows for daily family tasks such as scheduling/calendaring, tasks/lists and presence/chat, etc. In addition, the growing trend of information syndication to public network services (such as social networks, picture repositories, blogging, and/or the like) is supported. Data created by distributed applications may be entirely private for provisioned devices contained within the household. This data may not be accessible externally unless the data is published externally using a CG server gateway provider, which may require consent and privilege by the household (approval is received to promote the data externally).

The CG system provides controls for certain users in positions of authority over the network (e.g., parents) to make decisions on data access, user access, and access to endpoints where data may be transmitted. These features are user driven, but are enabled and configured through policy. These features may be enabled when syndication add-ins are installed on the CG server provider gateway and made available to the group.

The data and interaction for applications which are more data rich or have more persistent models (e.g., shared calendar, lists) are modeled for a family collaboration group. As a result, all users have access to a centralized dataset. On the other hand, ‘n’ stand-alone datasets may offer support for publishing, aggregation, or segmentation. The model permits multiple users in the group to have access to the same data objects associated with a given application. For example, there may be one calendar for the household to use as the primary. However, individual entries may be access controlled in a manner appropriate to allow visibility levels relative to permission or ownership.

The ability to create unique views unrelated to the primary data may also be provided. This feature may be used for private or public (federated) cases requested by members of a group. Access and filtering of views with a data object is controlled through access control, as discussed above. Data objects (e.g., documents) may be provided with access control down to elements within the document as part of view locking, in addition to general discretionary control on the object and subordinate context. In a server topology, the server may maintain the application data (e.g., calendar object) as a committed origin or master copy. Client nodes may have working views of the data stored locally. This working view supports a concurrency access-based transaction scheme and use coordination between the server and nodes. Coordination is supported through a multicast channel assigned to each particular application (each application has a unique application multicast channel). Each application issues events relative to its interaction on the data to the group, with the server or nodes processing/handling the requests against the document using a queue processing model. This architecture is similar to a memory mapped file, but across multiple device nodes, using a multicast channel to pivot and transact upon the shared data. In one embodiment, changes may use a combination of lazy/optimistic locking and a region locking scheme between commits to the origin or master copy. This ensures that views of the data are synchronized between the clients and client/server. A deferred processing procedure may be used to converge data to other nodes, and to help ensure that the local cache of other nodes are current. In the peer topology, the data sharing coordination architecture may be similar, with the exception of not having an origin or master document. As such, each peers may have a fully editable version of the document, and may use the protection and synchronization scheme to ensure that the document remains consistent across all nodes, and that each node is able to use the document without issue. These features generally apply to all the data rich collaboration applications provided with the system.

Other applications, such as presence, which have lower or different persistence and interaction requirements for data, are also enabled for a family collaboration group. As with data rich applications, these applications also coordinate state transition, presence, and message events that are communicated across the channel. The distinction for an application such as chat is that more targeted needs exist for 1:1 or 1:N communications. This is an example of where filters, discussed earlier, become relevant.

Application data is partitioned based upon an association of the respective application, and is persisted in the storage facilities on the server and/or client as defined by the application. Application objects, attributes, settings and state are stored and managed through the CG system with some aspects being local and some aspects being global. Some operational and auxiliary application data may be distributed through the management channels, since these are used to support system infrastructure scenarios such as enrollment, discovery, system initialization, and/or the like. Applications may have a user experience (UX) component which makes their workflows integrated, easy to use, and symmetric in experience across different devices. UX can be either server- or client-side, with the server-side being more commonly used for management application used for integration to a server management dashboard. The client may be a stand-alone application with an application provider integrating into the local management dashboard.

Household users with an appropriate level of permissions may manage the collaboration group or other entities configured to be managed via management applications within the CG system. This feature may be viewed as “computers/devices” which are fully provisioned for users and group assignment, applications and updates, within the overall CG system. While some systems may provide limited management capability today, these capabilities are local to the system, explicit to the system (e.g., do not function across groups) and/or are not easy to use locally or in a distributed manner. In one embodiment, a basic dashboard is provided by the CG system which may help centralize and highlight details (e.g., system experienced an error condition) that are relevant, actionable, consumable by the user, and that may otherwise be overlooked. Since the CG architecture utilizes a parental control model, a distributed policy pattern is used to push down settings to client devices, thereby managing the state of the system. Additionally, in one embodiment, a user may remote manage devices in the CG system, or may seek assistance through delegation. As one example, an assistance request may be federated out of the network, or may be transmitted to a peer within the same CG.

Abstraction of OS capability enables cross platform integration and support. Some embodiments of the present disclosure solve problems in a generic way that is cross platform. Management functions are built natively into the CG software stack and use capability providers to map to OS- or platform-specific capabilities. This abstraction may allow true end-to-end management to work cross-platform. OS abstraction may also be supported by the expansion features described herein. Since OS capability is constantly changing and the CG system is extensible, the CG system may support functionality for adding/changing/deleting integration providers as needed.

Third-party providers may also be enabled. This is different than application class integration since management is deeply integrated into the CG system. Third parties may integrate application set and/or management provider capability for the CG system. All management may have a server and a local user experience (UX) which makes these workflows integrated, easy to use, and symmetric in experience for the parental control model described above. UX can be either server- or client-side, both being used as a management provider which is integrated with their respective dashboard.

A subset of core collaboration applications and system management functionality may be exposed using a website page provided by a CG device such as a server device. This may enable some core scenarios in the cases where a full agent installation on a client device is not possible or fully supported. In addition, this allows the device to access published resources (e.g., shared calendar) or perform some basic management functions (e.g., authorize a user) without having access to an enrolled device.

As described above, FIG. 14 illustrates two exemplary device nodes having CG applications installed on them, according to various aspects of the present disclosure. The device 814 is installing server software 800, whereas the device 864 is installing client software 850. First, the server software 800 is installed. The installer for the server software 800 calls the registration APIs 801, and the registration APIs call a registrar subsystem 802. the registrar subsystem 802 uses the security subsystem 803 and the policy subsystem 804 for verification. The registrar subsystem 802 then calls the dispatcher to create an entry in the app table 805, and calls the directory subsystem 806 to store application specific information, such as app objects, attributes, identifier details, and/or the like. The directory subsystem 806 commits the application request into the appropriate local scope 808b and global scope 808a namespace sections of the directory store 807. Then, the registrar subsystem 802 calls the network subsystem 809 to create a new channel 811 for the application. The network subsystem 809 creates a new channel in the channel map 810, creates a new channel object in the connection management facility, and enables the channel 811. The application 800 may now call I/O APIs 812 and communicate with the CG system using the I/O subsystem, since the application is now valid and authorized, and communication bindings are set up. Once the server side is setup, the client side software 850 can then be installed in a similar manner.

After a CG has been set up, a non-CG enabled device may be bootstrapped and enrolled to the CG system. Functionality to do this may vary depending upon the type of device being enrolled. For example, a native installer technology which works on a Windows PC may not work on a smart phone, so alternative enrollment techniques, such as using a browser based enrollment workflow, may be supported. In either case, use of mutual authentication TLS to the installer web server without using or working around a lack of other available mediums (e.g., USB Key, floppy, UNC sharing, etc.) may be provided.

Generally, one embodiment of a process of enrolling or provisioning a device into a CG system may install/register the service binaries and appropriate components, create a default configuration (e.g., file, registry, cache, and/or the like), set appropriate permissions, and begin system initialization and enrollment. One embodiment of system initialization may include, but is not limited to, setting up a collaboration group; specifying a topology type (client/server or peer-to-peer); creating an object store and default objects (including settings/state); creating a group root certificate authority; establishing service and server identities; setting default administrators; obtaining user preferences; enabling default system stores; installing server side applications; enabling an enrollment system; and enabling access to the system.

As outlined in the previous discussion of CG system setup, a server device should be the first device installed to the CG system in the case of a client/server topology. Clients may enroll in the CG system by obtaining a client certificate issued from the server. Subsequently, all communications between the client and the server are mutually authenticated (client/server authorization) using TLS. A server identity is created when the system is installed in client/server mode, which enables it to be first device in the CG and the authority for the system realm. The server becomes the certificate authority for the collaboration group during installation. The server may designate itself as the signed root certificate which provides the basis for authority chain verification, claims or certificate issuance including and exceeding identity certificates (client or server). The client identity may be obtained during device enrollment which may also include a system installation step; a system initialization procedure (which is specific to client and does not involve installation of a root CA but does involve installing the server root certificate); requesting a client identity from the server; switching to TLS; negotiating capabilities; installing client applications; finishing initialization; and transferring control to the user.

Client enrollment bootstrap may occur by downloading a client enrollment package from the group server website; by using a removable computer-readable medium (USB key, floppy, cd, etc.) having the client enrollment package; or accessed via the network, such as over a UNC share or from an FTP server. When installing in a peer topology, the peers act as both a client and a server, so the scenario may be very similar with server setup, except as follows: Each device installs a self-signed root CA, and uses both a client and a server identity certificate. Server and client applications are both installed, and peer enrollment mode is enabled so the user can download a peer enrollment package. The peer groups then merge into a shared group which occurs for each peer that is added. Distribution methods for the peer enrollment package are similar to the client enrollment process outlined above. One difference is the content of the package itself, and in particular, the contents and the installation intention. Discovery of the server and enrollment endpoints may occur via static entry in the enrollment package (which is created when the server is built), via a discovery port on the server which responds to multicast discovery requests, or via some other method.

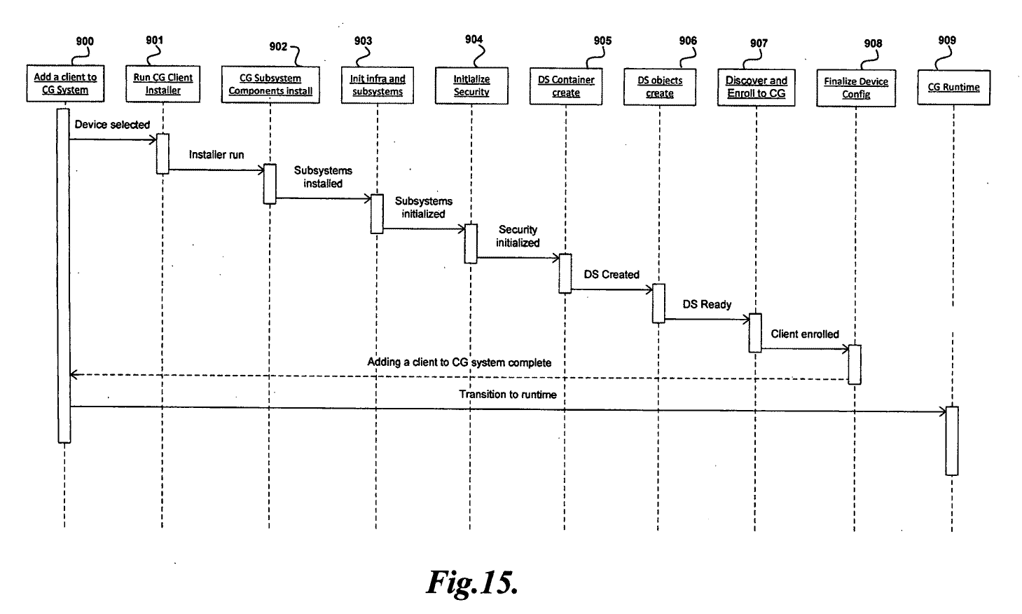

FIG. 15 is a sequence diagram illustrating one embodiment of a method for adding a new device to a CG system, according to various aspects of the present disclosure. Many steps are similar to those outlined above with respect to FIG. 14. However, FIG. 15 includes a CG discovery and enrollment step 907, and includes changes during a finalize device configuration step 908. CG discovery and enrollment includes locating the CG system on the local subnet and provisioning the device to be enrolled into the system. Discovery of the server and enrollment endpoints may occur via a static entry in the enrollment package (which is created when the server is built) and/or via a discovery port on the server which responds to multicast discovery requests. The discovery procedure resulting from use of a network discovery operation may use the multicast management channel, outlined in FIGS. 10A and 10B. The client device issues a “discovery” operation, and the CG system responds with the details, including an IP address/port, of the device to connect to for the enrollment operation. The response may also contain the authentication type.

The default authentication type for connecting the client to the enrollment device to pair the client device to the CG system may use PIN pair identifiers. The client device receives the PIN pair from the enrollment device, and a user inputs the PIN into an enrollment UI on the client device being added to the CG system. In one embodiment, TLS requiring a temporary client identifier certificate may also be used, as well as other types of authentication, since the CG authentication system is extensible.

The enrollment procedure finalizes establishing the client identity and provisioning state by issuing an enrolled client certificate which takes the place of the temporary client identifier certificate, if this authentication type was used. The CG root authority certificate is installed on the client device, a device role type in the CG (client or peer) is set, and any appropriate permissions and policies from the CG are synchronized down to the client device before proceeding further. The role type is specified by the CG since the user specified role type during CG creation, as depicted in FIG. 14.

The finalizing device configuration 908 step will includes a directory store sync operation with the CG system during finalizing device configuration 908 as depicted in other parts of this disclosure. This will be a full sync, since the device has no context or state from the CG, and its newly created directory store starts out empty. The client device is now in a CG runtime state with the system.

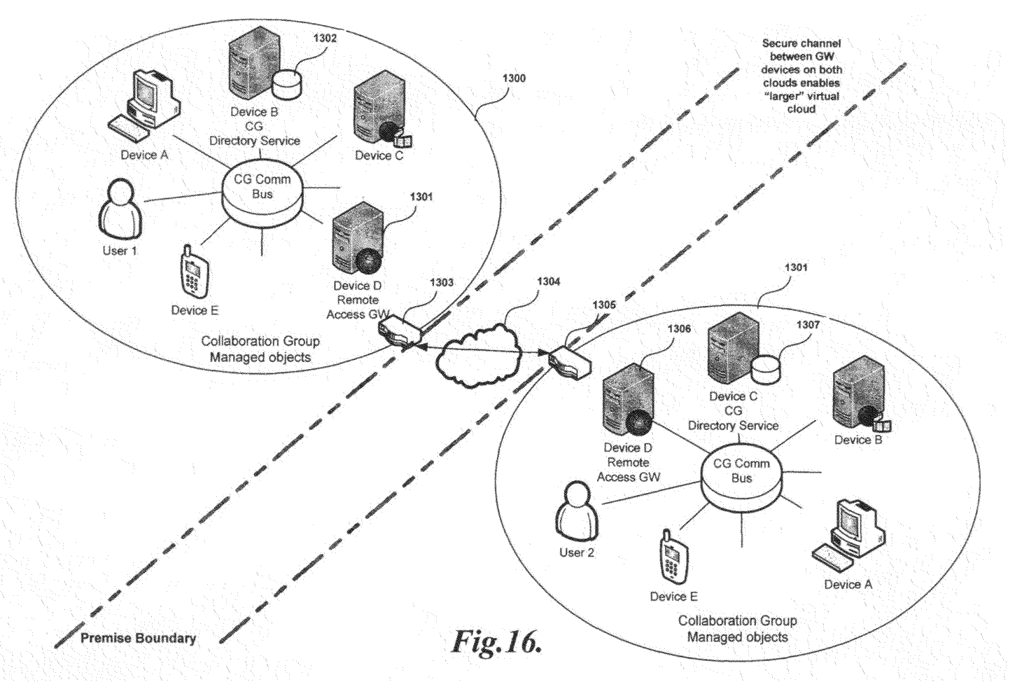

FIG. 16 illustrates an inter-cloud topology according to various aspects of the present disclosure. To set up this topology, in one embodiment, User 1 configures a remote access role on the device D 1301 in cloud 1 1300, and specifies an access PIN which will be used to mutually authenticate the clouds. At the same time, User 2 configures a remote access role on device D 1306 in cloud 2 1301. Either user may initiate the binding request, but for this example user 1 may use a CG management app to setup the inter-cloud link to cloud 2. They will specify the remote cloud address either by a fully qualified domain name (FQDN) or by an IP address of the network device 1303, 1305 to connect via a public network 1304 such as the interne. The network devices 1303, 1305 both have been configured for remote access GW in the NAT (network address table) to allow the IP requests to route to the appropriate device. In this case, the inbound request is coming to device D on cloud two 1306. User 2 is able to see the pairing request via a management UI, and enters the PIN associated with cloud 1 1300. When this occurs, a notification on user 1's management UI may appear, at which time User 1 will enter the PIN associated with cloud 2 1301. When this mutual agreement occurs, the binding between the two clouds will be active, and transport level interaction between the clouds may occur. In one embodiment, the first operation is a cloud-to-cloud sync, after which administrators may use delegation to authorize remote administrators to perform selected tasks in their CG cloud. Also, applications are now able to take advantage of objects and state from either cloud, since the directory stores are distributed to both clouds. Data is also tenanted accordingly within the CG catalog and DS. In one embodiment, by default, administrators in cloud 1 1300 may be granted limited admin rights in cloud 2 1301, and vice versa. Also, administrators in cloud 2 1301 may specify delegation with administrators in cloud 1 1300, but that is not default behavior.

Embodiments of the CG system may support upgrades. An upgrade may, in effect, be a natural over-install procedure over the defined install procedure for the server in server topology. However, clients may be serviced through the management unicast channel using update archetype semantics built natively in the client/server management protocol. This process may include core infrastructure and application level capabilities. Software distribution points on the server may also be updated as part of the server upgrade, so all client related bits may be updated at origin to support already enrolled devices and new installations. During the upgrade or servicing process, agent binaries, settings, and state may be added, modified or deleted on the device as warranted by the specific upgrade/servicing package build. As with setup, the upgrade or servicing installation packages may be verified for trust using binary level signing.

The system supports un-installation and this will in effect, be a natural “uninstall” sequence of the platform specific installation package. This can be accomplished by running the uninstall on the appropriate node (server or client). The server can also issue “remote uninstall” commands using the management unicast channel and/or remote application management semantics built natively into the client/server management protocol. During the uninstall process, all agent binaries, settings, state which have been configured, created on, or simply added to the device are removed. This will include certificates which were created for the system.

While illustrative embodiments have been illustrated and described, it will be appreciated that various changes can be made therein without departing from the spirit and scope of the invention. For example, the functionality of various components described separately herein may be provided by a single component, or the functionality of a single component described herein may be provided by two or more separate components. Furthermore, computer-executable components described herein may be stored on a tangible computer-readable medium, such as a hard disk, floppy disk, flash drive, optical drive, and/or the like. Computers and/or devices described herein may include any type of computing device having a processor and a memory. One embodiment of a computing device is a desktop computer. In other embodiments, a computing device may be a laptop computer, a tablet computer, a server computer, a smartphone, a-PDA, an embedded device, and/or the like.

The embodiments of the invention in which an exclusive property or privilege is claimed are defined as follows:

1. A nontransitory computer-readable medium having computer-executable components stored thereon that, if executed by one or more processors of a computing device, cause the computing device to participate in a collaboration group; the computer-executable components comprising:
a directory store containing information identifying a plurality of application objects available for use within the collaboration group;
an application configured to:
submit a query via a directory store API to retrieve an object from the directory store identifying a target for application communication; and
submit an I/O request to an I/O API containing information intended for the target for application communication; and
a network subsystem for transmitting data to and receiving data from other computing devices in the collaboration group, the network subsystem including:
one or more application channels; and
a channel map configured to associate each application channel of the one or more application channels with an application object in the directory store;
wherein the network subsystem is configured to:
receive an I/O request from the application via the I/O API;
determine an appropriate application channel for transmitting data included in the I/O request by inspecting the channel map; and
transmit the data included in the I/O request to the target for application communication via the appropriate application channel.
